(19) United States
(12) Patent Application Publication
(10) Pub. No.: US 2012/0072160 A1
(43) Pub. Date: Mar. 22, 2012

(54) MEASURE PRESENTATION DEVICE, MEASURE PRESENTATION METHOD, AND NON-TRANSITORY COMPUTER READABLE STORAGE MEDIUM

(75) Inventors: Tsunenori Machii, Kawasaki (JP); Junichi Yoshio, Kawasaki (JP)

(73) Assignee: Fujitsu Limited, Kawasaki (JP)

(21) Appl. No.: 13/172,225

(22) Filed: Jun. 29, 2011

(30) Foreign Application Priority Data
Sep. 22, 2010 (JP) 2010-212166

(51) Int. Cl. G06F 15/00

(52) U.S. Cl. 702/127

(57) ABSTRACT

A measure presentation device includes a measure storage unit that stores a measure content group in which a measure content performed against a phenomenon of a device and the next measure content determined by the execution result of the measure content are associated with each other. The measure storage unit stores split measures that are associated with several measure contents with respect to one execution result. Moreover, the measure presentation device includes a history storage unit that stores therein measure procedures performed against the phenomenon of the device in past times and the success or failure of the execution result for the measure procedures. Moreover, the measure presentation device includes an evaluating unit that evaluates the effectiveness of a split destination measure for a split measure stored in the measure storage unit on the basis of the success or failure of the execution result in the measure procedures.

### CROSS-REFERENCE TO RELATED APPLICATION

This application is based upon and claims the benefit of priority of the prior Japanese Patent Application No. 2010-212166, filed on Sep. 22, 2010, the entire contents of which are incorporated herein by reference.

### FIELD

The embodiments discussed herein are directed to a measure presentation device, a non-transitory computer readable storage medium.

### BACKGROUND

Monitoring has been conventionally performed on various types of devices that constitute an IT (information technology) system. For example, an IP (internet protocol) network may be provided with a network monitor that monitors a router, a switch, and the like as a monitoring target device. The network monitor informs a network administrator or the like of a warning when the failure of the monitoring target device is detected, for example.

There has been recently known a measure presentation device that presents measures against a failure to the network administrator when the network monitor detects that the monitoring target device has the failure. For example, the measure presentation device presents the measures on the basis of information on the failure received from the network monitor, and presents the next measures on the basis of the execution result of the measures when the measures are executed by the network administrator. In other words, the network administrator sequentially executes the measures presented by the measure presentation device to deal with the failure of the monitoring target device. The technique has been known as disclosed in, for example, Japanese Laid-open Patent Publication No. 6-119174.

However, the conventional measure presentation device may make a network administrator select the measures for an execution target. Specifically, the conventional measure presentation device may present a plurality of measures without narrowing down measures to be next presented into one, depending on the failures and the measures of a monitoring target device. In this case, the network administrator selects the measures for an execution target from the plurality of measures presented by the conventional measure presentation device on the basis of the own capability and experience. This causes a problem that effective measures may not be performed on a failure because only individual measures are performed on the failure of the monitoring target device.

The problem may be also caused when the network monitor detects a possibility of the failure of the monitoring target device. Furthermore, the problem may be caused also when the network monitor and the measure presentation device are integrated with each other.

### SUMMARY

According to an aspect of an embodiment of the invention, a measure presentation device includes a measure storage unit that stores therein measure contents that are sequentially performed on a phenomenon of a device in association with an execution result of one measure content and a measure content performed next to the measure content; a history storage unit that stores therein measure procedure histories indicating the measure contents sequentially performed in past times against the phenomenon of the device and successes or failures of the measure procedure histories; an evaluating unit that evaluates, when the phenomenon occurs from the device, which of measure procedures including measure contents that are split from and associated with one execution result is effective among measure procedures determined from the measure contents stored in the measure storage unit on the basis of the successes or the failures of the measure procedure histories stored in the history storage unit; and a presenting unit that presents the measure procedure that is evaluated to be effective by the evaluating unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating an example configuration of an IP network according to a first embodiment;

FIG. 2 is a diagram illustrating an example configuration of a measure presentation device according to the first embodiment;

FIG. 3 is a diagram illustrating a relationship between scenario parts stored in a scenario storage unit;

FIG. 4 is a diagram illustrating an example of a scenario part stored in the scenario storage unit;

FIG. 5 is a diagram illustrating an example of attribute information;

FIG. 6 is a diagram illustrating an example of incident information;

FIG. 7 is a diagram illustrating an example of phenomenon history information;

FIG. 8 is a diagram illustrating an example of attribute history information;

FIG. 9 is a diagram illustrating an example of scenario part statistical information;

FIG. 10 is a diagram illustrating an example of various types of information included in new incident notification;

FIG. 11 is a diagram illustrating an example of a scenario pattern candidate extracted by a candidate extracting unit;

FIG. 12 is a diagram illustrating an example of an incident similarity given by a history extracting unit;

FIG. 13 is a diagram illustrating an example of a narrowing down process that is performed by the history extracting unit and an execution result applying unit;

FIG. 14 is a diagram illustrating an example of a scenario pattern history selected by a filter unit;

FIG. 15 is a diagram illustrating an example of an item that becomes the grounds of a priority set by a priority processing unit;

FIG. 16 is a flowchart illustrating processing procedures that are performed by the measure presentation device according to the first embodiment;

FIG. 17 is a flowchart illustrating history extraction processing procedures that are performed by the history extracting unit;

FIG. 18 is a flowchart illustrating execution result application processing procedures that are performed by the execution result applying unit;

FIG. 19 is a flowchart illustrating filter priority processing procedures that are performed by the filter unit and the priority processing unit;

FIG. 20 is a diagram illustrating an example configuration of a measure presentation device according to a second embodiment;

FIG. 21 is a diagram illustrating an example of a narrowing down process that is performed by the execution result applying unit and the history extracting unit; and

FIG. 22 is a diagram illustrating a hardware configuration example of a computer that realizes a measure presentation process.

### DESCRIPTION OF EMBODIMENTS

Preferred embodiments of the present invention will be explained with reference to accompanying drawings.

The present invention is not limited to the embodiments explained below.

### [a] First Embodiment

### Configuration of IP Network of First Embodiment

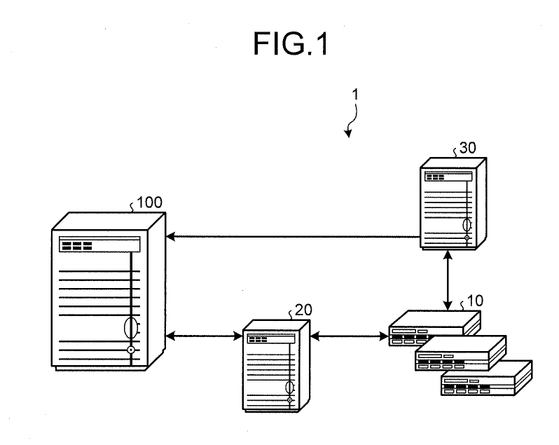

It will be explained about an IP network that includes a measure presentation device according to the first embodiment with reference to FIG. 1. FIG. 1 is a diagram illustrating an example configuration of an IP network 1 according to the first embodiment. As illustrated in FIG. 1, the IP network 1 according to the first embodiment includes a monitoring target device 10, a state management device 20, a network monitor 30, and a measure presentation device 100.

The monitoring target device 10 is various types of devices included in the IP network 1. For example, the monitoring target device 10 is a router, a switch, a server, and the like. The monitoring target device 10 is monitored by the network monitor 30.

The state management device 20 manages various states of the monitoring target device 10. Specifically, the state management device 20 acquires various types of information from the monitoring target device 10 and saves the acquired information. For example, the state management device 20 transmits ping to the monitoring target device 10 to save information on the conduction state of the monitoring target device 10. Moreover, the state management device 20 acquires various logs from the monitoring target device 10 and saves the acquired logs. Furthermore, the state management device 20 saves information on the operating state of communication ports of the monitoring target device 10 when the monitoring target device 10 is a router, a switch, and the like.

The network monitor 30 monitors whether the monitoring target device 10 operates normally. For example, the network monitor 30 performs polling on the monitoring target device 10 to monitor the operating state of the monitoring target device 10. Moreover, when the monitoring target device 10 autonomously reports a warning, the network monitor 30 monitors the operating state of the monitoring target device 10 on the basis of the warning received from the monitoring target device 10.

Then, when it is detected that the monitoring target device 10 has a phenomenon such a failure, the network monitor 30 informs a network administrator or the like of the warning. In the following embodiments, a “phenomenon” indicates, for example, a failure that is caused by the monitoring target device 10, an event in which there is a possibility that the monitoring target device 10 has a failure, or the like. As an example, the “phenomenon” includes an event in which a response to ping is not output from the monitoring target device 10, an event in which the monitoring target device 10 has a heavy load, and the like.

When it is detected that the monitoring target device 10 has a phenomenon, the network monitor 30 transmits a new incident notification that indicates the generation of the phenomenon to the measure presentation device 100. At this time, the network monitor 30 transmits a new incident notification that includes phenomenon information indicative of the contents of the phenomenon, attribute information on the monitoring target device 10, and the like. As an example, phenomenon information included in the new incident notification includes information that indicates an event in which a response to ping is not output from the monitoring target device 10, like the example. Moreover, as an example, attribute information on the monitoring target device 10 included in the new incident notification includes the device name, the maker, the model name, and the like of the monitoring target device 10.

When the new incident notification is received from the network monitor 30, the measure presentation device 100 presents a measure procedure that is performed on the phenomenon. Moreover, the term “measure procedure” indicates a combination of measures that are sequentially performed on the phenomenon. For example, the “measure procedure” presented by the measure presentation device 100 includes information that includes a measure A, a measure B, and a measure C and indicates the process of the measures in order of the measure A, the measure B, and the measure C.

Herein, the measure presentation device 100 stores, every phenomenon of the monitoring target device 10 that can occur, a measure procedure candidate that is performed on the phenomenon. In some cases, the measure procedure stored in the measure presentation device 100 can include a measure that is split into next several measures with respect to one execution result. In other words, in the case of a measure included in the measure procedure stored in the measure presentation device 100, the next measures may not be uniquely determined by the execution result of the measure in some cases.

When a new incident notification is received from the network monitor 30, the measure presentation device 100 that stores the measure procedures presents a measure procedure that is effective against the failure of the monitoring target device 10, among the measure procedures that are saved in the device itself. Specifically, the measure presentation device 100 performs the next process.

The measure presentation device 100 stores, as history information, measure procedures executed in past times and the execution results of the measure procedures. Then, when a new incident notification is received, the measure presentation device 100 evaluates, with respect to one measure result, effectiveness for a split destination measure of a split measure that is split into a plurality of measures on the basis of the history information. In other words, the measure presentation device 100 evaluates which route's measure procedure is effective with respect to a measure procedure including a split measure on the basis of the history information, that is, which route's measure procedure has a high possibility for solving a phenomenon.

Then, the measure presentation device 100 presents a measure procedure that goes through a split measure and a split destination measure that are effective. As a result, the measure presentation device 100 according to the first embodiment can present an effective measure procedure against the phenomenon of the monitoring target device 10.

The configuration of the IP network 1 in which the measure presentation device 100 according to the first embodiment is placed is not limited to the example illustrated in FIG. 1. For example, the measure presentation device 100 may be integrated with the state management device 20. Meanwhile, the measure presentation device 100 may be integrated with the network monitor 30. Furthermore, the measure presentation device 100 may be integrated with the state management device 20 and the network monitor 30. The measure presentation device 100 according to the first embodiment can be applied also when measure procedures are presented against phenomena of various types of devices that constitute another IT system such as a radio system in addition to the IP network.

It will be below explained in detail about the measure presentation device 100 according to the first embodiment. Hereinafter, a measure procedure can be referred to as a “scenario pattern” and one measure included in a measure procedure can be referred to as a “scenario part”. A scenario pattern can be a plurality of scenario parts that is arranged in accordance with a certain sequence.

Configuration of Measure Presentation Device of First Embodiment

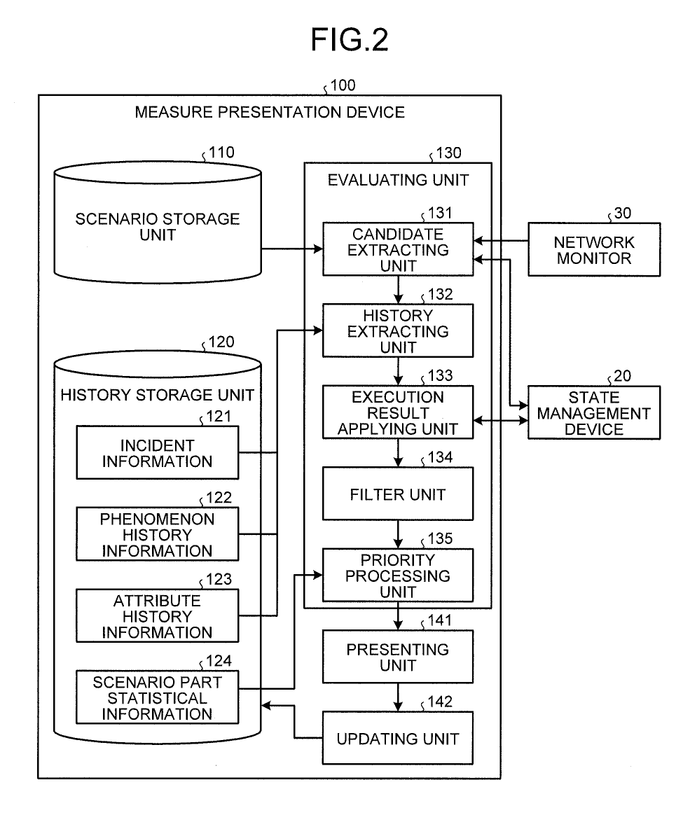

Next, it will be explained about the measure presentation device 100 according to the first embodiment with reference to FIG. 2. FIG. 2 is a diagram illustrating an example configuration of the measure presentation device 100 according to the first embodiment. As illustrated in FIG. 2, the measure presentation device 100 according to the first embodiment includes a scenario storage unit 110, a history storage unit 120, an evaluating unit 130, a presenting unit 141, and an updating unit 142.

The scenario storage unit 110 stores therein scenario parts that are sequentially performed against the phenomenon of the monitoring target device 10, by using an association between the execution result of one scenario part and a scenario part performed next to the one scenario part. In other words, the scenario storage unit 110 can be called a measure storage unit. Herein, the plurality of scenario parts stored in the scenario storage unit 110 includes scenario parts that are associated in accordance with one execution result. Hereinafter, scenario parts that are associated in accordance with one execution result can be referred to as “split scenario parts” in some cases.

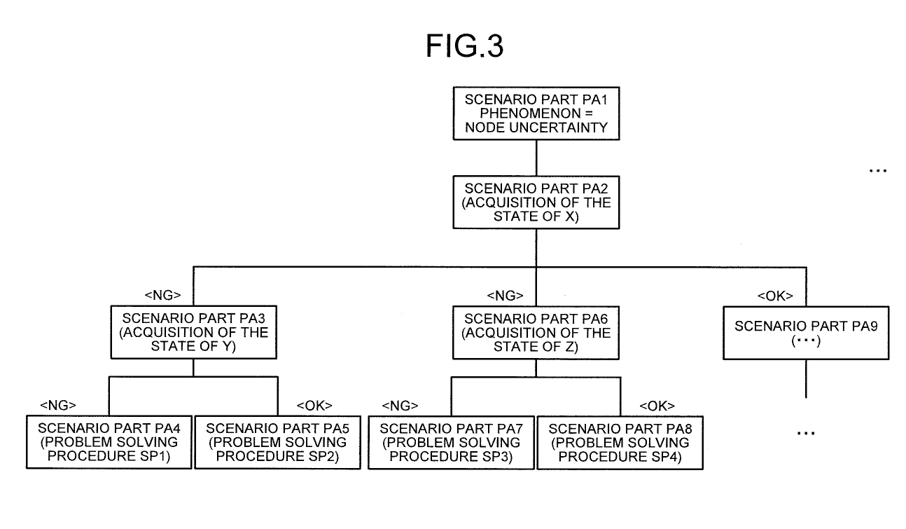

It will be explained about a relationship between scenario parts stored in the scenario storage unit 110 with reference to FIG. 3. FIG. 3 is a diagram illustrating a relationship between scenario parts stored in the scenario storage unit 110. In FIG. 3, scenario parts PA1 to PA9 stored in the scenario storage unit 110 are illustrated.

In an example illustrated in FIG. 3, the scenario part PA1 indicates a phenomenon of the monitoring target device 10, attribute information of the monitoring target device 10 having the phenomenon, and the like.

Specifically, the scenario part PA1 indicates a phenomenon “node uncertainty”. The “node uncertainty” indicates, for example, a phenomenon in which a response of ping is not output from the monitoring target device 10. Attribute information indicated in the scenario part PA1 will be later described. Moreover, the scenario part PA1 is the first scenario part of the scenario pattern and does not have a measure. Hereinafter, a scenario part that does not have a measure like the scenario part PA1 can be referred to as an “introduction scenario part” in some cases.

Each of the scenario parts PA2 to PA9 indicates a measure performed against the phenomenon indicated by the scenario part PA1. Specifically, the scenario part PA2 indicates a measure “acquisition of the state of X”, the scenario part PA3 indicates a measure “acquisition of the state of Y”, and the scenario part PA6 indicates a measure “acquisition of the state of Z”. The “acquisition of the state” indicates, for example, that various states of the monitoring target device 10 are acquired from the state management device 20.

The scenario part PA4 indicates a measure “problem solving procedure SP1” and the scenario part PA5 indicates a measure “problem solving procedure SP2”. Moreover, the scenario part PA7 indicates a measure “problem solving procedure SP3” and the scenario part PA8 indicates a measure “problem solving procedure SP4”. The “problem solving procedure” indicates, for example, a measure for “rebooting the monitoring target device 10”, a measure for “contacting a network administrator”, and the like.

The example illustrated in FIG. 3 indicates that a scenario part performed next to the scenario part PA1 is the scenario part PA2. The example indicates that a scenario part performed next to the scenario part PA2 is any of the scenario part PA3, the scenario part PA6, and the scenario part PA9. The example indicates that a scenario part performed next to the scenario part PA3 is any of the scenario part PA4 and the scenario part PA5. The example indicates that a scenario part performed next to the scenario part PA6 is any of the scenario part PA7 and the scenario part PA8.

The scenario storage unit 110 stores the scenario parts PA1 to PA9 in association with the execution results of the scenario parts. Specifically, the scenario storage unit 110 stores the scenario part PA3 and the scenario part PA6 in association with the execution result “NG” of the scenario part PA2. Moreover, the scenario storage unit 110 stores the scenario part PA9 in association with the execution result “OK” of the scenario part PA2. Moreover, the scenario storage unit 110 stores the scenario part PA4 in association with the execution result “NG” of the scenario part PA3 and stores the scenario part PA5 in association with the execution result “OK” of the scenario part PA3. Moreover, the scenario storage unit 110 stores the scenario part PA7 in association with the execution result “NG” of the scenario part PA6 and stores the scenario part PA8 in association with the execution result “OK” of the scenario part PA6.

In other words, when the execution result of the measure “acquisition of the state of X” of the scenario part PA2 is “NG” in the example illustrated in FIG. 3, a candidate of a scenario part to be referred to next is the scenario part PA3. Similarly, when the execution result of the measure “acquisition of the state of X” of the scenario part PA2 is “NG”, a candidate of a scenario part to be referred to next is the scenario part PA6. Moreover, when the execution result of the measure “acquisition of the state of X” of the scenario part PA2 is “OK”, a candidate of a scenario part to be referred to next is the scenario part PA9.

In this way, scenario parts stored in the scenario storage unit 110 include split scenario parts that are split into several scenario parts from one execution result. Specifically, as illustrated in FIG. 3, when the measure “acquisition of the state of X” of the scenario part PA2 is “NG”, a candidate of a scenario part performed next to the scenario part PA2 is any of the scenario parts PA3 and PA6. In other words, when the measure “acquisition of the state of X” of the scenario part PA2 is “NG”, which of the scenario parts PA3 and PA6 is performed next to the scenario part PA2 cannot be uniquely specified. In this way, the scenario storage unit 110 stores split scenario parts for which a scenario part to be performed next is not uniquely specified even if an execution result becomes clear.

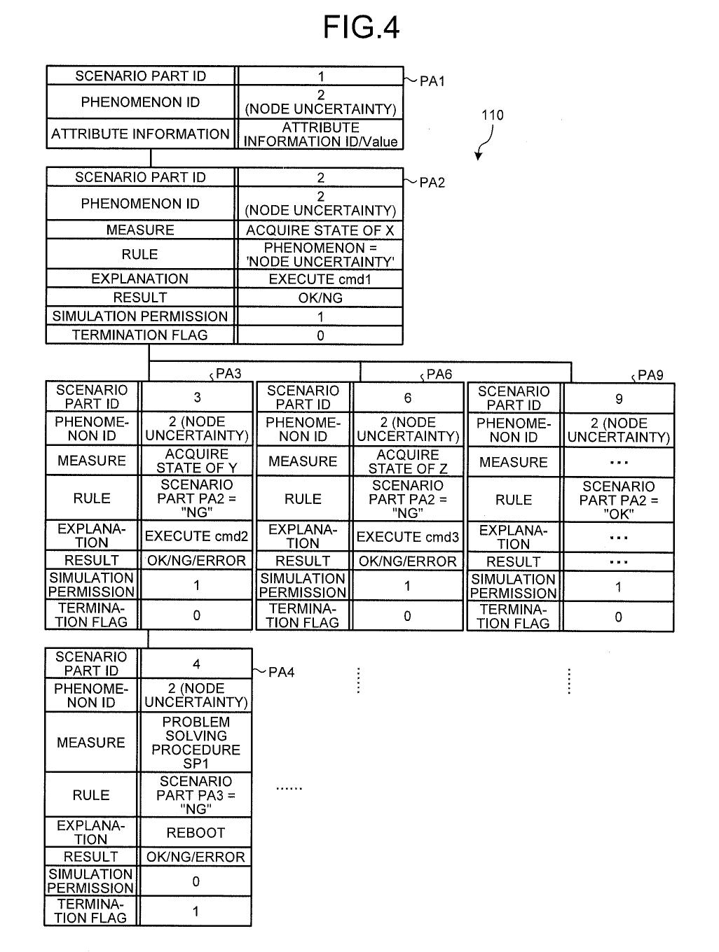

Next, it will be explained in detail about the configuration of scenario parts stored in the scenario storage unit 110 with reference to FIG. 4. FIG. 4 is a diagram illustrating an example of scenario parts stored in the scenario storage unit 110. In FIG. 4, the scenario parts PA1 to PA4, PA6, and PA9 of FIG. 3 are illustrated.

As illustrated in FIG. 4, the scenario part PA1 stored in the scenario storage unit 110 has items such as for example “scenario part ID”, “phenomenon ID”, and “attribute information”. Moreover, the scenario parts PA2 to PA4, PA6, and PA9 stored in the scenario storage unit 110 have items such as for example “scenario part ID”, “phenomenon ID”, “measure”, “rule”, “explanation”, “result”, “simulation permission”, and “termination flag”.

In the example illustrated in FIG. 4, the scenario part PA1 actually has “measure”, “rule”, “explanation”, “result”, “simulation permission”, and “termination flag”. However, because the scenario part PA1 is an introduction scenario part, the scenario part PA1 may not have information on “measure” and the like. Therefore, “measure” and the like of the scenario part PA1 are omitted in FIG. 4. The scenario part PA2 and the like other than an introduction scenario part have “attribute information”. However, information may not be stored in the “attribute information”. Therefore, “attribute information” of the scenario part PA2 or the like is omitted in FIG. 4.

In other words, the introduction scenario part has items such as for example “scenario part ID”, “phenomenon ID”, and “attribute information”. The scenario parts other than the introduction scenario part have items such as for example “scenario part ID”, “phenomenon ID”, “measure”, “rule”, “explanation”, “result”, “simulation permission”, and “termination flag”. Moreover, when the “measure” of the split scenario part (the scenario part PA2) of FIG. 4 is performed, there may be several scenario parts (the scenario parts PA3 and PA6) for which the same execution result is described in the “rule”.

The “scenario part ID” indicates identification information that identifies a scenario part. In the example illustrated in FIG. 4, it is assumed that the numeric value described behind “PA” is “scenario part ID” among numbers of the scenario parts. The “phenomenon ID” indicates identification information that identifies a phenomenon of the monitoring target device 10 that can occur. In the example illustrated in FIG. 4, it is assumed that a phenomenon ID “2” indicates “node uncertainty”.

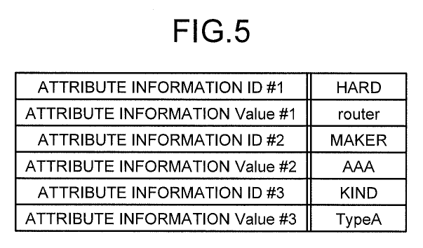

The “attribute information” indicates device information of the monitoring target device 10. FIG. 5 illustrates an example of attribute information. As illustrated in FIG. 5, the “attribute information” includes several attribute items that are the combination of “attribute information ID” and “attribute information Value”. In an example illustrated in FIG. 5, “attribute information ID” and “attribute information Value” form one set of attribute items in which “N” of “#N” behind “attribute information ID” and “attribute information Value” is the same value.

The “attribute information ID” of the attribute information is an identifier of attribute information and the “attribute information Value” is an attribute corresponding to the identifier of the attribute information. In the example of FIG. 5, “attribute information ID #1” and “attribute information Value #1” correspond to each other, and “attribute information ID #N and “attribute information Value #N” correspond to each other. For example, the “attribute information ID #1” indicates the type of hardware. An attribute corresponding to the type ID #1, that is, the “attribute information Value #1” includes a router, a server, a terminal, and the like. They indicate the type of device information. The “attribute information Value” indicates the contents of device information. In the example illustrated in FIG. 5, “HARD” stored in the “attribute information ID #1” indicates the device name of the monitoring target device 10. Moreover, the “attribute information ID #2” indicates a vendor name or the like that is the maker of hardware. Moreover, the “attribute information ID #3” indicates the model name of hardware. In other words, the attribute information illustrated in FIG. 5 indicates that the device name of the monitoring target device 10 is “router”, the maker is “AAA”, and the model is “Type A”.

It should be noted that attribute information is not limited to the example illustrated in FIG. 5. For example, attribute information may include the name of OS (operating system), the name of application software, the version of an application, and the like, which are installed on the monitoring target device 10.

The “measure” indicates a content that is performed against the phenomenon of the monitoring target device 10. The content of “measure” is a content that should be performed against the content of “phenomenon ID” of the scenario part. The “rule” indicates association information between scenario parts, and determines whether its own scenario part is a scenario part that is performed next to another scenario part. Specifically, the “rule” includes a description on “phenomenon”, another scenario part ID, and an execution result thereof.

For example, “phenomenon=node uncertainty” is described in the “rule” of the scenario part PA2 illustrated in FIG. 4. In this way, a scenario part in which a phenomenon is described in “rule” is associated with an introduction scenario part. Specifically, the scenario part PA2 is associated with the scenario part PA1 in which “2 (node uncertainty)” is described in a phenomenon ID. In other words, the scenario part in which “phenomenon” is described in “rule” is a scenario part that is referred to next to the introduction scenario part.

“The scenario part PA2=NG” is described in the “rule” of the scenario part PA3. In this way, the scenario part in which the execution result of another scenario part is described in the “rule” is associated with the other scenario part. Specifically, the scenario part PA3 is associated with the scenario part PA2, and becomes the candidate of a scenario part to be referred to next when the result of the measure “acquisition of the state of X” of the scenario part PA2 is “NG”.

The “explanation” is information for a network administrator, and is the explanation for “measure”. For example, a network administrator can refer to information stored in “explanation” to perform a measure in some cases.

The “result” is information that may be the execution result of “measure”. For example, the execution result of the measure “acquisition of the state of X” of the scenario part PA2 illustrated in FIG. 4 can be any of “OK” and “NG”. Moreover, the execution result of the measure “acquisition of the state of Y” of the scenario part PA3 can be any of “OK”, “NG”, and “ERROR”.

Herein, the execution result of a measure is illustrated when the “result” is “OK” or “NG” and the execution result of a measure cannot be determined when the “result” is “ERROR”. For example, it is assumed that “measure” is “to confirm whether an error log is output”. At this time, when it can be confirmed that an error log is not output from the monitoring target device 10, the “result” becomes “OK” because the monitoring target device 10 does not have an error. Meanwhile, when it can be confirmed that an error log is output from the monitoring target device 10, the “result” becomes “NG” because the monitoring target device 10 has an error. On the other hand, when it cannot be confirmed whether an error log is output from the monitoring target device 10, the “result” becomes “ERROR” because the measure cannot be performed.

The “simulation permission” is information that indicates whether its scenario part is a scenario part that may be automatically executed by a system. In the example illustrated in FIG. 4, when “1” is stored in “simulation permission”, it indicates that its scenario part is a scenario part that can be automatically executed by the system. Moreover, when “0” is stored in “simulation permission”, it indicates that its scenario part is a scenario part that cannot be automatically executed by the system. In other words, in the example illustrated in FIG. 4, the scenario parts PA2, PA3, PA6, and PA9 can be automatically executed by the system, and the scenario part PA4 cannot be automatically executed by the system. When the automatic execution by the system is not permitted, there is performed an operation for displaying a measure and pressing for the measure to an operator.

The “termination flag” is information that indicates whether its own scenario part is a scenario part to be finally executed in the scenario pattern. The example illustrated in FIG. 4 indicates that its own scenario part is a scenario part to be finally executed in the scenario pattern when “1” is stored in the “termination flag”. Meanwhile, when “0” is stored in the “termination flag”, the example indicates that its own scenario part is not a scenario part to be executed finally. In other words, in the example illustrated in FIG. 4, the scenario parts PA2, PA3, PA6, and PA9 are not a scenario part to be finally executed in the scenario pattern, and the scenario part PA4 is a scenario part to be finally executed in the scenario pattern.

Moreover, the scenario parts PA2 to PA9 that are associated with the introduction scenario part PA1 that stores the phenomenon ID “2” are illustrated in the examples illustrated in FIGS. 3 and 4. However, the scenario storage unit 110 also stores scenario parts that are associated with an introduction scenario part other than the scenario part PA1. In other words, the scenario storage unit 110 also stores scenario parts that are performed against phenomena other than the phenomenon “node uncertainty”. Furthermore, the scenario storage unit 110 may store introduction scenario parts that have different attribute information even if the phenomenon IDs are the same. In other words, even if the phenomena are the same, the scenario storage unit 110 may store different scenario parts when the monitoring target device 10 has different attribute information.

Returning to FIG. 2, the history storage unit 120 stores, as history information, various types of information on the scenario patterns that are sequentially performed in past times against the phenomenon of the monitoring target device 10, the success or failure of the execution results for the scenario patterns, and the like. Specifically, the history storage unit 120 stores incident information 121, phenomenon history information 122, attribute history information 123, and scenario part statistical information 124.

The incident information 121 stores the past phenomenon of the monitoring target device 10 and the scenario pattern performed against the phenomenon in association with each other. Hereinafter, a combination of the phenomenon and the scenario pattern stored in the incident information 121 can be described as an “incident”.

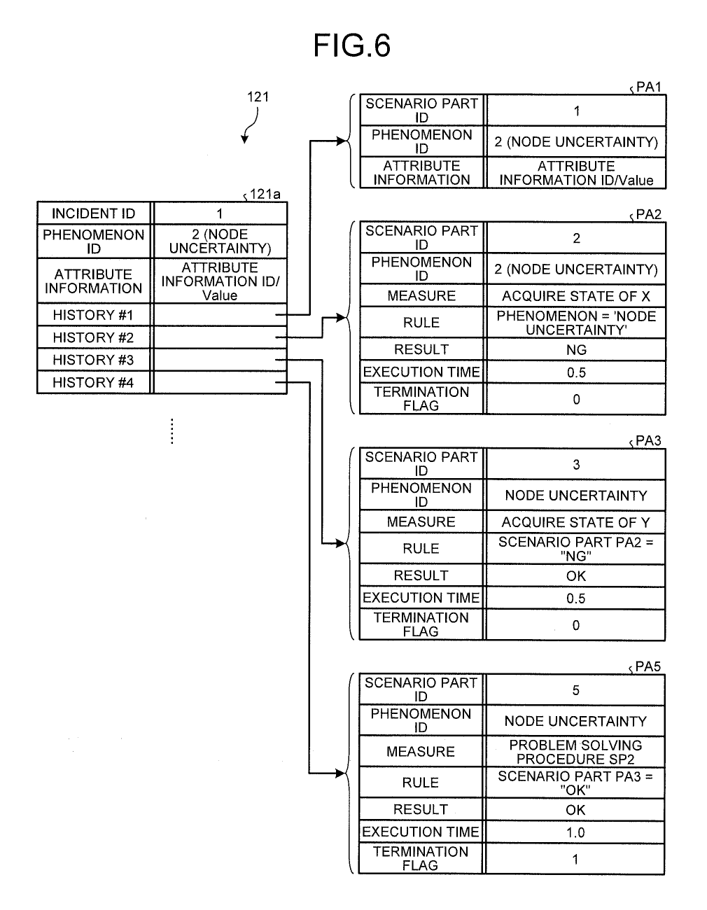

FIG. 6 illustrates an example of the incident information 121. In FIG. 6, an incident 121a that is one incident of the incident information 121 is illustrated. As illustrated in FIG. 6, the incident 121a has items such as for example “incident ID”, “phenomenon ID”, “attribute information”, and “history”.

The “incident ID” is identification information that identifies an incident. The “phenomenon ID” corresponds to the phenomenon ID illustrated in FIG. 4. The “attribute information” is attribute information of the monitoring target device 10 from which a phenomenon has occurred in past times. The data structure of the “attribute information” is similar to the example illustrated in FIG. 5.

A scenario pattern performed in past times is stored in the “history”. Specifically, as illustrated in FIG. 6, the incident 121a has “histories #1 to #N (N is a natural number)”. Scenario parts that are sequentially executed in the ascending order of the values of “N” are stored in the “histories #1 to #N”. For example, the incident 121a illustrated in FIG. 6 indicates that scenario parts stored in “history #1”, “history #2”, “history #3”, and “history #4” are executed in this order. In other words, the incident 121a indicates that the scenario part PA1, the scenario part PA2, the scenario part PA3, and the scenario part PA5 are executed in this order.

Herein, the “result” of a scenario part stored in the “history” indicates the execution result of the scenario part. In this case, the “result” of the scenario part illustrated in FIG. 4 indicates information that can be the execution result of “measure” and the “result” of the “history” illustrated in FIG. 6 indicates the actual execution result of the scenario part. Moreover, the execution time of a scenario part is stored in the “execution time” of the scenario part stored in the “history”. The example illustrated in FIG. 6 indicates that the execution result of the scenario part PA2 is “NG” and the execution time of the scenario part PA2 is “0.5 (time)”. Furthermore, the example indicates that the execution result of the scenario part PA3 is “OK” and the execution time of the scenario part PA3 is “0.5 (time)”. Additionally, the example indicates that the execution result of the scenario part PA5 is “OK” and the execution time of the scenario part PA5 is “1.0 (time)”.

In the example illustrated in FIG. 6, the total execution time of the scenario patterns stored in the incident 121a can be computed like “0.5”+“0.5”+“1.0”=“2.0” (time). Moreover, the example indicates that the execution results of the scenario patterns stored in the incident 121a are “OK”. This reason is that the result of the final scenario part PA5 of the scenario patterns stored in the incident 121a is “OK”. In other words, the individual incident information refers to the “result” of the final scenario part stored in the “history”. If its value is a value indicative of a success (“OK” in the example, it can be determined that the scenario pattern is successful.

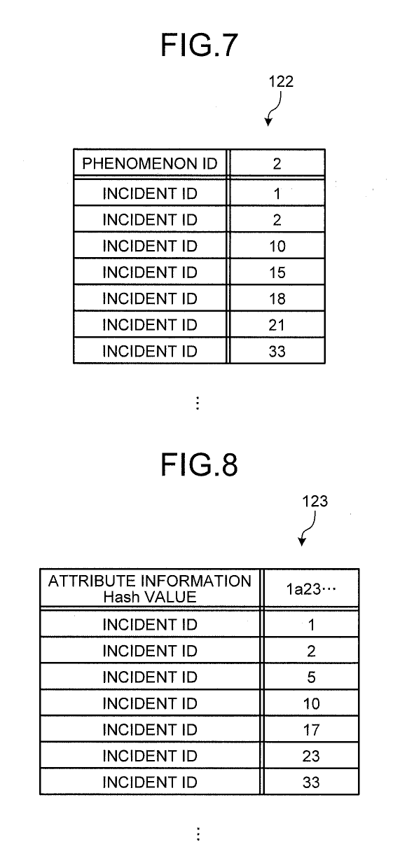

The phenomenon history information 122 stores a past phenomenon of the monitoring target device 10 and an incident obtained by performing a scenario pattern against the phenomenon, in association with each other. FIG. 7 illustrates an example of the phenomenon history information 122. As illustrated in FIG. 7, the phenomenon history information 122 stores “incident ID” in association with “phenomenon ID”. An example illustrated in FIG. 7 indicates that the incident IDs of incidents that store the phenomenon ID “2” are “1”, “2”, “10”, “15”, “18”, “21”, and “33”. Moreover, the phenomenon history information 122 stores the phenomenon IDs and the incident IDs of other phenomenon IDs other than the phenomenon ID “2” in association with each other. It may be said that the phenomenon history information 122 stores, every phenomenon ID, a scenario pattern realized by the phenomenon ID.

The attribute history information 123 stores attribute information of the monitoring target device 10 from which a phenomenon has occurred in past times and an incident that is obtained by performing a scenario pattern on the monitoring target device 10 that has the attribute information, in association with each other. FIG. 8 illustrates an example of the attribute history information 123. As illustrated in FIG. 8, the attribute history information 123 stores an “incident ID” in association with an “attribute information Hash value”. It may be said that the attribute history information 123 stores a scenario pattern that is performed on the monitoring target device having the same attribute information.

The “attribute information Hash value” is a hash value of attribute information. For example, the hash value is computed by MD5 (Message Digest Algorithm 5) or the like. For example, it is assumed that the attribute information of the monitoring target device 10 from which a phenomenon has occurred in past times is information illustrated in FIG. 5. In this case, the “attribute information Hash value” is, for example, a hash value of “HARD=router, MAKER=AAA, KIND=Type A”.

The example illustrated in FIG. 8 indicates that the incident IDs of the incidents obtained by performing scenario patterns on the monitoring target device 10 for which the Hash value of attribute information is “1a23 . . . ” are “1”, “2”, “5”, “10”, “17”, “23”, and “33”. Moreover, the attribute history information 123 stores an attribute information Hash value and an incident ID in association with each other with respect to other attribute information Hash values other than the attribute information Hash value “1a23 . . . ”.

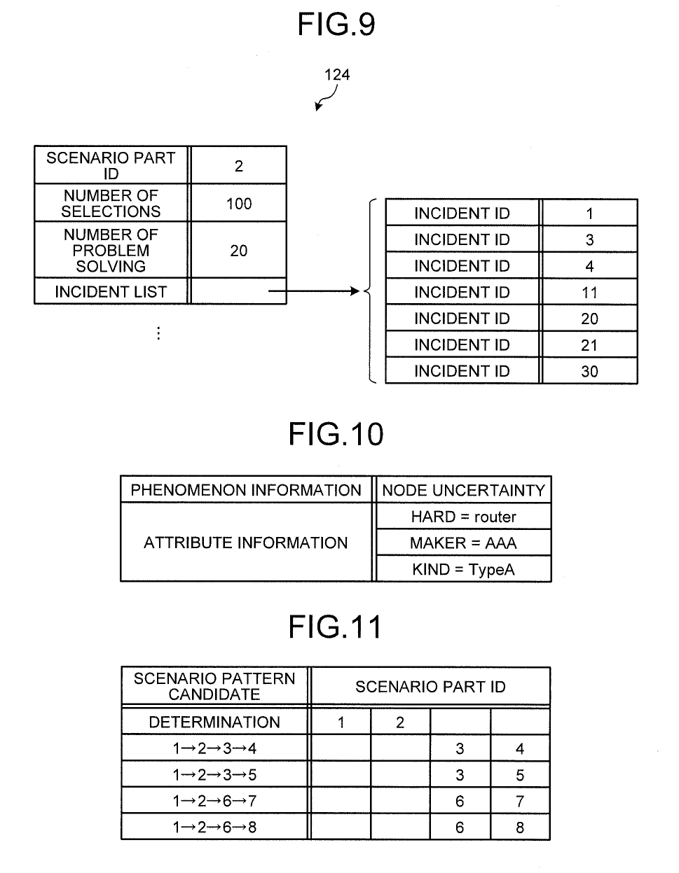

The scenario part statistical information 124 stores, every scenario part stored in the scenario storage unit 110, statistical information on the scenario part. FIG. 9 illustrates an example of the scenario part statistical information 124. As illustrated in FIG. 9, the scenario part statistical information 124 has items such as for example “scenario part ID”, “number of selections”, “number of problem solutions”, and “incident list”.

The “scenario part ID” corresponds to the scenario part ID illustrated in FIG. 4. The “number of selections” indicates the number by which the scenario part indicated by the scenario part ID has been selected and executed in past times. The “number of problem solutions” indicates the number by which the scenario pattern including the scenario part indicated by the scenario part ID has been executed in past times to solve the phenomenon. The “incident list” indicates an incident ID of an incident by which the scenario part indicated by the scenario part ID is stored in the “history”.

The example illustrated in FIG. 9 indicates that the phenomenon has been solved “20” times by executing the scenario part PA2 of which the scenario part ID is “2” “100” times in past times and by executing the scenario pattern including the scenario part PA2. The example illustrated in FIG. 9 indicates that the scenario pattern including the scenario part PA2 is executed in the incidents of which the incident IDs are “1”, “3”, “4”, “11”, “20”, “21”, and “30”.

Returning to FIG. 2, when the monitoring target device 10 has a phenomenon, the evaluating unit 130 evaluates which of the scenario patterns including a split scenario part is effective on the basis of the success or failure of the incident information 121 stored in the history storage unit 120. Specifically, when the monitoring target device 10 has a phenomenon, the evaluating unit 130 extracts a scenario pattern candidate that becomes an execution candidate from the plurality of scenario parts stored in the scenario storage unit 110. Then, the evaluating unit 130 evaluates to which of the scenario parts the split is effectively performed among the split scenario parts included in the scenario pattern candidate, on the basis of the success or failure of the execution result of the already-executed scenario pattern stored in the history storage unit 120. The evaluating unit 130 includes a candidate extracting unit 131, a history extracting unit 132, an execution result applying unit 133, a filter unit 134, and a priority processing unit 135.

When the monitoring target device 10 has a phenomenon, the candidate extracting unit 131 acquires the plurality of scenario parts corresponding to this phenomenon from the scenario storage unit 110, and extracts a scenario pattern associated with the acquired scenario part.

Specifically, when the monitoring target device 10 has a phenomenon, the candidate extracting unit 131 receives a new incident notification from the network monitor 30. Then, the candidate extracting unit 131 acquires, from the scenario storage unit 110, an introduction scenario pattern for which phenomenon information included in the new incident notification and attribute information of the monitoring target device 10 are identical to. Then, the candidate extracting unit 131 extracts the extracted introduction scenario pattern and a scenario pattern associated with the introduction scenario pattern as a scenario pattern candidate. Moreover, the candidate extracting unit 131 virtually executes a measure content that is described in the “measure” of each the scenario part included in the scenario pattern candidate. At this time, when “1 (automatic execution permission)” is described in the “simulation permission” of each the scenario part included in the scenario pattern candidate, the candidate extracting unit 131 actually executes the measure content described in the “measure” of each the scenario part.

In general, the measure for a phenomenon is changed depending on a device name, a maker, or a model name of the monitoring target device 10 from which a phenomenon occurs. However, a measure may not be changed depending on the device name or the like. Therefore, the candidate extracting unit 131 may acquire, from the scenario storage unit 110, an introduction scenario pattern for which only the phenomenon information included in the new incident notification is identical to.

It will be explained about a candidate extraction process that is performed by the candidate extracting unit 131 by using an example illustrated in FIG. 10. FIG. 10 is a diagram illustrating an example of various types of information included in a new incident notification. In the following explanation, it is assumed that the scenario storage unit 110 stores at least the scenario parts PA1 to PA9 illustrated in FIGS. 3 and 4. Moreover, it is assumed that the attribute information of the scenario part PA1 stores attribute information illustrated in FIG. 5.

The new incident notification illustrated in FIG. 10 includes phenomenon information “node uncertainty” and attribute information “HARD=router”, “MAKER=AAA”, “KIND=Type A”. In other words, the new incident notification illustrated in FIG. 10 indicates that a phenomenon called “node uncertainty” occurs from a router of which the maker is “AAA” and the model name is “Type A”.

When the new incident notification illustrated in FIG. 10 is received, the candidate extracting unit 131 acquires an introduction scenario part that stores phenomenon information and attribute information included in the new incident notification from the scenario storage unit 110. Herein, as illustrated in FIG. 4, the scenario part PA1 stored in the scenario storage unit 110 is an introduction scenario part and stores phenomenon ID “2 (node uncertainty)”. Moreover, the scenario part PA1 stores attribute information “HARD=router”, “MAKER=AAA”, and “KIND=Type A”. In other words, the phenomenon ID and attribute information of the scenario part PA1 are identical with the phenomenon information and attribute information included in the new incident notification illustrated in FIG. 10. Therefore, when the new incident notification illustrated in FIG. 10 is received, the candidate extracting unit 131 acquires the scenario part PA1 as an introduction scenario part from the scenario storage unit 110.

Next, the candidate extracting unit 131 extracts a scenario part associated with the scenario part PA1 acquired from the scenario storage unit 110. In the example illustrated in FIG. 3, because the scenario parts PA2 to PA9 are associated with the scenario part PA1, the candidate extracting unit 131 acquires the scenario parts PA1 to PA9 from the scenario storage unit 110.

Then, the candidate extracting unit 131 aligns the scenario parts in execution order on the basis of the information stored in the “rule” of each of the scenario parts PA1 to PA9, and virtually executes a measure content described in the “measure” of each of the scenario parts in sequence from the introduction scenario part. At this time, when “1 (automatic execution permission)” is described in the “simulation permission”, the candidate extracting unit 131 actually executes a measure content described in the “measure” of the scenario part. Then, when it reaches a split scenario part as the execution result of the measure content of each the scenario part, the candidate extracting unit 131 extracts a scenario pattern candidate on the basis of the measure result.

It is specifically explained by using an example illustrated in FIG. 11. FIG. 11 is a diagram illustrating an example of a scenario pattern candidate that is extracted by the candidate extracting unit 131. In this case, “N1->N2->N3->N4” illustrated in the “scenario pattern candidate” of FIG. 11 indicate the execution sequence of the scenario parts, and N1, N2, N3, and N4 indicate scenario part IDs. For example, “1->2->3->4” indicate scenario pattern candidates that are executed in order of the scenario parts PA1, PA2, PA3, and PA4.

First, it is decided that the scenario part PA2 is referred to next to the scenario part PA1 that is an introduction scenario part. Therefore, as illustrated in the first line of FIG. 11, the candidate extracting unit 131 definitely determines that the scenario part PA2 is referred to next to the scenario part PA1. Next, the candidate extracting unit 131 virtually executes the measure “acquisition of the state of X” of the scenario part PA2. For example, the candidate extracting unit 131 acquires the state of X from the state management device 20.

Herein, it is assumed that the execution result of the measure “acquisition of the state of X” is “NG”. In this case, the candidate extracting unit 131 determines that a scenario part that is performed next to the scenario part PA2 is the scenario part PA3 or PA6. In other words, the candidate extracting unit 131 determines that the scenario part PA9 is not performed next to the scenario part PA2. Herein, the candidate extracting unit 131 cannot uniquely specify a scenario part that is performed next to the scenario part PA2. Therefore, the candidate extracting unit 131 extracts, as a scenario pattern candidate, all the scenario patterns in which the scenario part PA3 or PA6 is performed next to the scenario parts PA1 and PA2.

Specifically, as illustrated in the second line of FIG. 11, the candidate extracting unit 131 extracts a scenario pattern that is executed in order of the scenario parts PA1, PA2, PA3, and PA4 as a scenario pattern candidate. Moreover, as illustrated in the third line of FIG. 11, the candidate extracting unit 131 extracts a scenario pattern that is executed in order of the scenario parts PA1, PA2, PA3, and PA5 as a scenario pattern candidate. Moreover, as illustrated in the fourth line of FIG. 11, the candidate extracting unit 131 extracts a scenario pattern that is executed in order of the scenario parts PA1, PA2, PA6, and PA7 as a scenario pattern candidate. Moreover, as illustrated in the fifth line of FIG. 11, the candidate extracting unit 131 extracts a scenario pattern that is executed in order of the scenario parts PA1, PA2, PA6, and PA8 as a scenario pattern candidate. At this time, the candidate extracting unit 131 does not extract a scenario pattern that is executed in order of the scenario parts PA1, PA2, PA9, . . . , as a scenario pattern candidate.

Returning to FIG. 2, when the monitoring target device 10 has a phenomenon, the history extracting unit 132 extracts an incident corresponding to a scenario pattern performed against this phenomenon in past times from the history storage unit 120.

Specifically, when the monitoring target device 10 has a phenomenon, the history extracting unit 132 receives the new incident notification transmitted by the network monitor 30 from the candidate extracting unit 131. Then, the history extracting unit 132 acquires an incident ID corresponding to phenomenon information included in the new incident notification from the phenomenon history information 122 of the history storage unit 120.

Next, the history extracting unit 132 computes, every incident acquired from the phenomenon history information 122, a similarity between the attribute information of the incident and the attribute information included in the new incident notification. In other words, the history extracting unit 132 can be called a computing unit. Hereinafter, a similarity between the attribute information of an incident and the attribute information included in the new incident notification may be described as “incident similarity”.

Then, the history extracting unit 132 extracts a scenario pattern that has been executed in past times, on the basis of the scenario part described in the “history” of the incident acquired from the phenomenon history information 122. Hereinafter, a scenario pattern that has been executed in past times may be described as a “scenario pattern history”. Then, the history extracting unit 132 extracts a scenario pattern history, which is identical to the scenario pattern candidate extracted by the candidate extracting unit 131, among scenario pattern histories extracted from the phenomenon history information 122.

Hereinafter, it will be explained about an incident similarity computation process that is performed by the history extracting unit 132. First, the history extracting unit 132 acquires an incident ID identical to all the attribute items of the attribute information included in the new incident notification from the attribute history information 123 of the history storage unit 120. Next, the history extracting unit 132 excludes an attribute item one-by-one from the attribute information included in the new incident notification, and acquires an incident ID identical to the attribute information except for the attribute item from the attribute history information 123.

For example, it is assumed that the new incident notification transmitted from the network monitor 30 is an example illustrated in FIG. 10. In this case, the history extracting unit 132 computes a hash value of all the attribute information “HARD=router, MAKER-AAA, and KIND=Type A” included in the new incident notification. Then, the history extracting unit 132 acquires an incident ID stored in association with the computed hash value from the attribute history information 123.

Next, the history extracting unit 132 excludes the attribute item “KIND=Type A” from the attribute information “HARD=router, MAKER=AAA, and KIND=Type A” included in the new incident notification. Then, the history extracting unit 132 computes a hash value of the attribute information “HARD=router, MAKER=AAA” except for the attribute item “KIND=Type A”, and extracts an incident ID stored in association with the computed hash value from the attribute history information 123.

The history extracting unit 132 excludes the attribute items “MAKER=AAA, KIND=Type A” from the attribute information “HARD=router, MAKER=AAA, and KIND=Type A” included in the new incident notification. Then, the history extracting unit 132 computes a hash value of the attribute information “HARD=router” except for the attribute items “MAKER=AAA, KIND=Type A”, and extracts an incident ID stored in association with the computed hash value from the attribute history information 123.

Then, the history extracting unit 132 gives the higher incident similarity to an incident that has more attribute items that are identical to the attribute information included in the new incident notification among the incidents acquired from the phenomenon history information 122. Specifically, the history extracting unit 132 gives the highest incident similarity to an incident that is identical to the hash value of all the attribute items of the attribute information included in the new incident notification among the incidents acquired from the phenomenon history information 122. Moreover, the history extracting unit 132 gives the second high incident similarity to an incident that is identical to the hash value of the attribute information except for one attribute item from the attribute information included in the new incident notification among the incidents acquired from the phenomenon history information 122. Then, the history extracting unit 132 gives the lowest incident similarity to an incident that is not identical to the attribute information included in the new incident notification among the incidents acquired from the phenomenon history information 122.

This example indicates that the history extracting unit 132 excludes an attribute item from attribute information in order of “KIND (model name)”, “MAKER (manufacturer)”, and “HARD (device name)”. This reason is that “HARD (device name)” of attribute information is information of specifying a device and has a higher level of importance than that of the other “KIND (model name)” and “MAKER (manufacturer)”. However, the history extracting unit 132 is not limited to the example. For example, the history extracting unit 132 may exclude an attribute item from attribute information in order of “MAKER (manufacturer)”, “HARD (device name)”, and “KIND (model name)”. Moreover, the history extracting unit 132 may compute a hash value for all combinations of attribute items and acquire an incident identical to the computed hash value from the phenomenon history information 122.

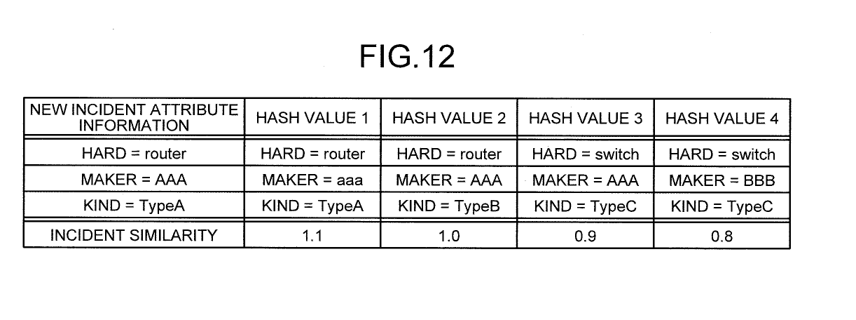

FIG. 12 illustrates an example of an incident similarity that is given by the history extracting unit 132. In an example illustrated in FIG. 12, “new incident attribute information” indicates attribute information included in the new incident notification transmitted from the network monitor 30. Moreover, “HASH value 1”, “HASH value 2”, “HASH value 3”, and “HASH value 4” indicate an example of attribute information stored in an incident that is identical with phenomenon information included in the new incident notification.

In the example illustrated in FIG. 12, the attribute information of “HASH value 1” is identical to new incident attribute information. In this case, the history extracting unit 132 gives an incident similarity “1.1” to an incident that stores the attribute information of “HASH value 1”. In the example illustrated in FIG. 12, “MAKER=AAA” is included in the new incident attribute information and “MAKER=aaa” is included in “HASH value 1”. However, it is assumed that an upper case letter and a lower upper case are not distinguished from each other.

Moreover, the attribute information of “HASH value 2” is identical with “HARD” and “MAKER” included in the new incident attribute information but is not identical with “KIND”. In other words, the attribute information of “HASH value 2” and the new incident attribute information are identical with each other with respect to items other than one item “KIND”. In this case, the history extracting unit 132 gives an incident similarity “1.0” to an incident that stores the attribute information of “HASH value 2”.

The attribute information of “HASH value 3” is identical with “HARD” included in the new incident attribute information but is not identical with “MAKER” and “KIND”. In this case, the history extracting unit 132 gives an incident similarity “0.9” to an incident that stores the attribute information of “HASH value 3”. Moreover, the attribute information of “HASH value 4” is not identical to all the items of the new incident attribute information. In this case, the history extracting unit 132 gives an incident similarity “0.8” to an incident that stores the attribute information of “HASH value 4”.

In this way, the history extracting unit 132 acquires an incident identical with the phenomenon information included in the new incident notification from the phenomenon history information 122. Then, the history extracting unit 132 gives a higher incident similarity to an incident that has more attribute items identical with the attribute information included in the new incident notification, among incidents identical with the phenomenon information included in the new incident notification.

Next, the history extracting unit 132 extracts a scenario pattern that has been executed in past times on the basis of the scenario parts stored in the “history” of the incident acquired from the phenomenon history information 122. For example, it is assumed that the history extracting unit 132 extracts an incident ID “1” from the phenomenon history information 122. Moreover, it is assumed that the incident indicated by the incident ID “1” is the incident 121a illustrated in FIG. 6. The incident 121a illustrated in FIG. 6 indicates the scenario pattern is executed in order of the scenario part PA1, the scenario part PA2, the scenario part PA3, and the scenario part PA5. Therefore, the history extracting unit 132 extracts, as a scenario pattern history, the scenario pattern executed in order of the scenario parts PA1, PA2, PA3, and PA5 from the incident 121a. In this way, the history extracting unit 132 extracts a scenario pattern history from all the incidents acquired from the phenomenon history information 122.

Then, the history extracting unit 132 extracts a scenario pattern history that is identical with the scenario pattern candidate extracted by the candidate extracting unit 131, among the scenario pattern histories extracted from the phenomenon history information 122.

The execution result applying unit 133 executes each scenario part included in the scenario pattern histories extracted by the history extracting unit 132. Specifically, the execution result applying unit 133 executes each the scenario part included in the scenario pattern histories, and narrows down a scenario pattern history on the basis of the execution result. In other words, the execution result applying unit 133 applies the present state of the monitoring target device 10 to the scenario pattern histories to narrow down a scenario pattern history.

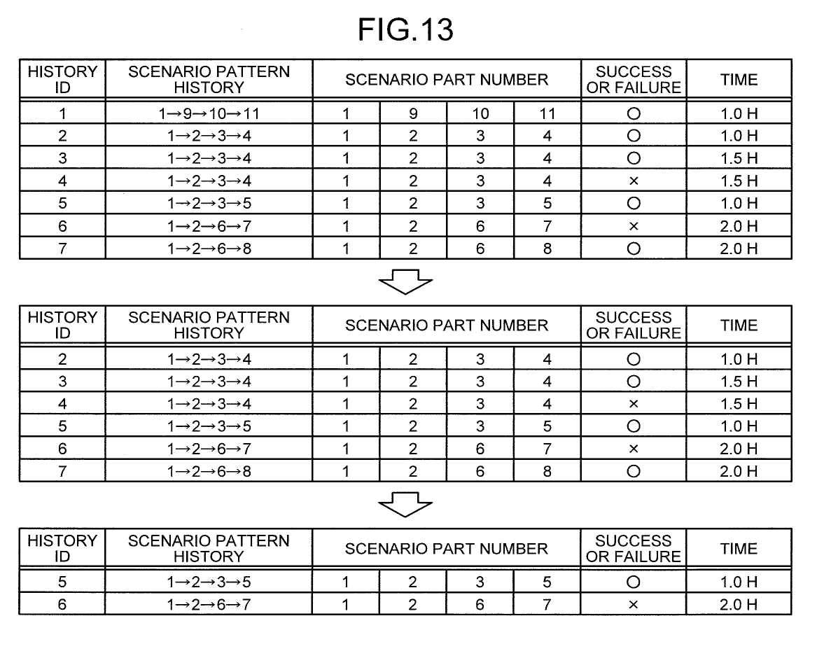

Now, it will be explained about a narrowing down process that is performed by the history extracting unit 132 and the execution result applying unit 133 with reference to FIG. 13. FIG. 13 is a diagram illustrating an example of a narrowing down process that is performed by the history extracting unit 132 and the execution result applying unit 133.

The upper stage of FIG. 13 illustrates a scenario pattern history that is acquired from the phenomenon history information 122 by the history extracting unit 132. Moreover, the “history ID” illustrated in FIG. 13 is identification information for identifying a scenario pattern history acquired by the history extracting unit 132. Moreover, the “success or failure” indicates the execution result of the scenario pattern history. Specifically, the “success or failure” indicates information stored in the “result” of the scenario part that is finally executed in the scenario pattern history.

Information may be stored by a network administrator in the “result” of the scenario part that is finally executed in the scenario pattern history. For example, when the final scenario part is executed among the scenario patterns included in the scenario pattern history and thus the phenomenon is solved, it is considered that the network administrator registers “OK” in the “result” of the scenario part that is finally executed in the scenario pattern history. On the other hand, when the final scenario part is executed and the phenomenon is not solved, it is considered that the network administrator registers “NG” in the “result” of the scenario part that is finally executed in the scenario pattern history.

In the example illustrated in FIG. 13, the scenario pattern history of which the “success or failure” is “∘” indicates that “OK” is stored in the “result” of the scenario part that is finally executed. On the other hand, the scenario pattern history of which the “success or failure” is “x” indicates that “NG” is stored in the “result” of the scenario part that is finally executed. Herein, a “time” indicates the execution time of a scenario pattern history. Specifically, a “time” indicates the total execution time of the scenario parts included in the scenario pattern history.

In the example illustrated in the upper stage of FIG. 13, the history extracting unit 132 acquires scenario pattern histories indicated by the history IDs “1” to “7” from the phenomenon history information 122. Specifically, the history extracting unit 132 acquires scenario pattern histories of “1->9->10->11”, “1->2->3->4”, “1->2->3->5”, “1->2->6->7”, and “1->2->6->8”. In this case, the history extracting unit 132 acquires three scenario pattern histories of “1->2->3->4”.

Herein, it is assumed that the scenario pattern candidates illustrated in FIG. 11 are extracted by the candidate extracting unit 131. In this case, the history extracting unit 132 extracts, among the scenario pattern histories illustrated in the upper stage of FIG. 13, a scenario pattern history that is identical with the scenario pattern candidate illustrated in FIG. 11. Herein, as illustrated in the middle stage of FIG. 13, the history extracting unit 132 extracts the scenario pattern histories of “1->2->3->4”, “1->2->3->5”, “1->2->6->7”, and “1->2->6->8” except the scenario pattern history of “1->9->10->11”.

Then, the execution result applying unit 133 executes a scenario part for which the execution is permitted among the scenario parts included in the scenario pattern history illustrated in the middle stage of FIG. 13. Specifically, the execution result applying unit 133 executes a scenario part in which “1” (automatic execution permission) is stored in the “simulation permission”. Herein, because the scenario parts PA1 and PA2 are already executed by the candidate extracting unit 131, the execution result applying unit 133 executes scenario parts other than the scenario parts PA1 and PA2.

Specifically, the execution result applying unit 133 executes a measure content stored in the “measure” of the scenario part PA3 corresponding to the scenario part ID “3” among the scenario parts included in the history IDs “2” to “5”. As illustrated in FIGS. 3 and 4, the measure content of the scenario part PA3 is “acquisition of the state of Y”. Therefore, the execution result applying unit 133 acquires, for example, the state of Y from the state management device 20. Moreover, the execution result applying unit 133 executes a measure content stored in the “measure” of the scenario part PA6 corresponding to the scenario part ID “6” among the scenario parts included in the history IDs “6” and “7”. As illustrated in FIGS. 3 and 4, the measure content of the scenario part PA6 is “acquisition of the state of Z”. Therefore, the execution result applying unit 133 acquires, for example, the state of Z from the state management device 20.

Herein, it is assumed that the execution result of the measure “acquisition of the state of Y” of the scenario part PA3 is “OK”. As illustrated in FIGS. 3 and 4, when the execution result of the measure “acquisition of the state of Y” of the scenario part PA3 is “OK”, the scenario part PA5 is executed next to the scenario part PA3. Therefore, the execution result applying unit 133 extracts the history ID “5” by which the scenario part PA5 is executed next to the scenario part PA3, among the history IDs “2” to “5” illustrated in the middle stage of FIG. 13.

Moreover, it is assumed that the execution result of the measure “acquisition of the state of Z” of the scenario part PA6 is “NG”. As illustrated in FIGS. 3 and 4, when the execution result of the measure content “acquisition of the state of Z” of the scenario part PA6 is “NG”, the scenario part PA7 is executed next to the scenario part PA6. Therefore, the execution result applying unit 133 extracts the history ID “6” by which the scenario part PA7 is executed next to the scenario part PA6 among the history IDs “6” and “7” illustrated in the middle stage of FIG. 13.

In other words, the execution result applying unit 133 narrows down the scenario pattern histories corresponding to the history IDs “2” to “7” illustrated in the middle stage of FIG. 13 to the scenario pattern histories corresponding to the history IDs “5” and “6” as illustrated in the lower stage of FIG. 13.

In this way, the execution result applying unit 133 executes the scenario pattern histories extracted by the history extracting unit 132 to narrow down a scenario pattern history. In other words, the execution result applying unit 133 narrows down the scenario pattern histories extracted by the history extracting unit 132 by using the present state of the monitoring target device 10 that has a phenomenon.

When the scenario parts included in the scenario pattern history are executed, the execution result applying unit 133 may store the execution result in the phenomenon history information 122. At this time, the execution result applying unit 133 stores the execution result of the scenario pattern history in the phenomenon history information 122 in such a manner that it can be determined that it is not the actually-performed incident but is the temporarily-executed incident. For example, a “temporary history flag” indicating whether an incident is a temporary incident may be provided in an incident ID, and whether an incident is a temporarily-executed incident may be determined by the “temporary history flag”.

The filter unit 134 selects a scenario pattern history for which the “result” of the scenario part that is finally executed in the scenario pattern history is a success, among the scenario pattern histories narrowed down by the execution result applying unit 133. In other words, the filter unit 134 executes the scenario pattern to select a scenario pattern history for which a phenomenon is solved. In other words, the filter unit 134 can be called a selecting unit.

It is explained by using the example illustrated in FIG. 13. Like the example illustrated in the lower stage of FIG. 13, scenario pattern histories are narrowed down into the scenario pattern histories corresponding to the history IDs “5” and “6” by the execution result applying unit 133. In this case, the filter unit 134 selects a scenario pattern history corresponding to the history ID “5” that indicates the success of “the success or failure”, among the scenario pattern histories corresponding to the history IDs “5” and “6”.

The priority processing unit 135 gives a priority to the scenario pattern history selected by the filter unit 134 on the basis of the incident similarity, the occurrence number of scenario patterns, the occurrence frequency of scenario patterns, a productive time, and the like. Moreover, the priority processing unit 135 does not perform the process when one scenario pattern history is selected by the filter unit 134. For example, when one scenario pattern history corresponding to the history ID “5” is selected by the filter unit 134 like the example illustrated in the lower stage of FIG. 13, the priority processing unit 135 does not perform the process.

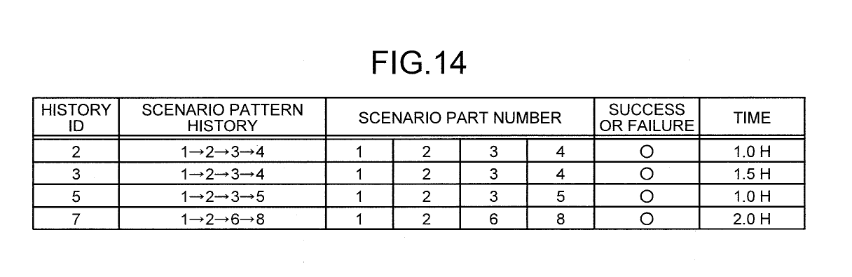

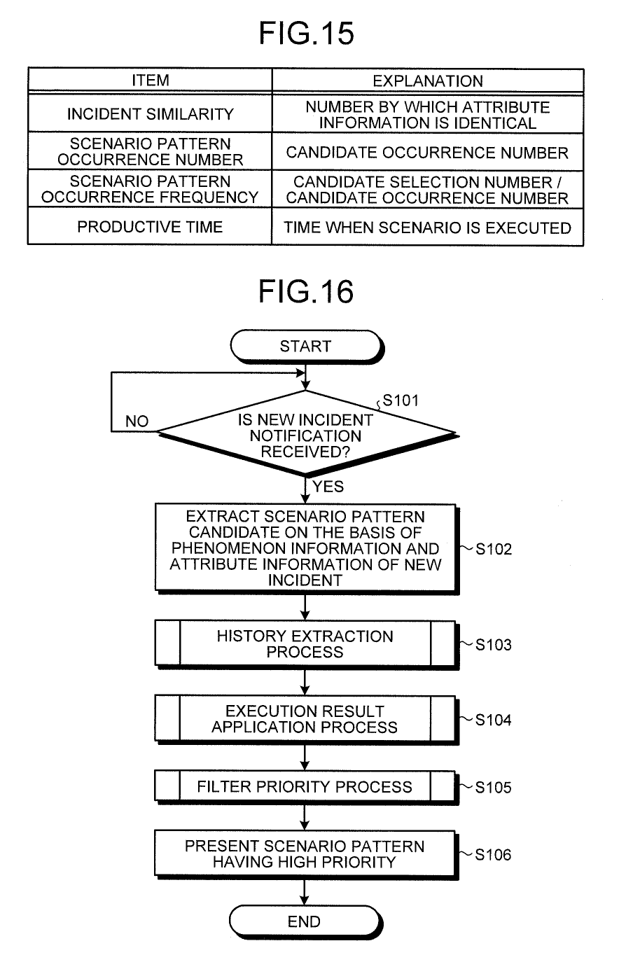

Now, it will be explained about a priority process that is performed by the priority processing unit 135 with reference to FIGS. 14 and 15. FIG. 14 is a diagram illustrating an example of a scenario pattern history selected by the filter unit 134. FIG. 15 is a diagram illustrating an example of items that become the ground of a priority set by the priority processing unit 135.

First, it will be explained about a scenario pattern history illustrated in FIG. 14. As described above, when an execution result application process is performed on the scenario pattern history illustrated in the middle stage of FIG. 13, the execution result applying unit 133 executes the measure content of the scenario part PA3 and the measure content of the scenario part PA6. Herein, it is assumed that the measure “acquisition of the state of Y” of the scenario part PA3 and the measure “acquisition of the state of Z” of the scenario part PA6 cannot be executed. In this case, the execution result applying unit 133 cannot narrow down the scenario pattern histories corresponding to the history IDs “2” to “7” illustrated in the middle stage of FIG. 13. In such a case, the filter unit 134 selects the history IDs “2”, “3”, “5”, and “7” that indicate the success of “the success or failure” among the scenario pattern histories corresponding to the history IDs “2” to “7”. In FIG. 14, the scenario pattern histories selected by the filter unit 134 in such a situation are illustrated.

When the plurality of scenario pattern histories is selected by the filter unit 134 like the example illustrated in FIG. 14, the priority processing unit 135 gives a priority to each the scenario pattern history on the basis of the items illustrated in FIG. 15. Specifically, as illustrated in FIG. 15, the priority processing unit 135 gives a priority to a scenario pattern history on the basis of the items such as for example “incident similarity”, “scenario pattern occurrence number”, “scenario pattern occurrence frequency”, and “productive time”.

The “incident similarity” indicates an incident similarity that is computed by the history extracting unit 132. For example, the priority processing unit 135 gives a higher priority to a scenario pattern history that has a larger incident similarity. This reason is that a scenario pattern that has a larger incident similarity is a scenario pattern that is performed on a phenomenon similar to the phenomenon of the monitoring target device 10.

The “scenario pattern occurrence number” indicates a total selection number by which the scenario parts included in the scenario pattern history have been selected in past times. Specifically, the scenario part statistical information 124 is associated with each scenario part included in the scenario pattern history. Like the example illustrated in FIG. 9, the scenario part statistical information 124 stores “the number of selections”. The “scenario pattern occurrence number” indicates a sum of “the number of selections” of the scenario parts included in the scenario pattern history. For example, the “scenario pattern occurrence number” of the scenario pattern history corresponding to the history ID “2” illustrated in FIG. 14 indicates a sum of “the number of selections” of the scenario parts PA1, PA2, PA3, and PA4. The priority processing unit 135 gives a higher priority to a scenario pattern history that has a larger scenario pattern occurrence number. This reason is that a scenario pattern that has a larger scenario pattern occurrence number is a scenario pattern that is more frequently executed in operation and thus has a higher reliability.

The “scenario pattern occurrence frequency” indicates a ratio of the number of executions of the scenario pattern to the “scenario pattern occurrence number”. Specifically, the incident information 121 of the history storage unit 120 stores the scenario pattern that has been executed in past times. In other words, the number of times of the scenario pattern that has been actually executed in past times can be calculated by referring to the incident information 121. The “scenario pattern occurrence frequency” is a value that is obtained by dividing the number of executions of the scenario pattern by the scenario pattern occurrence number. The priority processing unit 135 gives a higher priority to a scenario pattern history that has a larger scenario pattern occurrence frequency. This reason is that a scenario pattern that has a larger scenario pattern occurrence frequency is a scenario pattern that is more frequently executed in operation and thus has a higher reliability.

The “productive time” indicates a total execution time when the scenario pattern history is executed. The priority processing unit 135 gives a higher priority to a scenario pattern history that has a smaller productive time. This reason is that a scenario pattern that has a smaller productive time is a scenario pattern that can quickly respond to the phenomenon of the monitoring target device 10.

Meanwhile, the priority processing unit 135 may not give a priority like the example. For example, the priority processing unit 135 may give a higher priority to a scenario pattern history that has a smaller scenario pattern occurrence number. The setting method of a priority performed by the priority processing unit 135 can be changed by tuning up the system.

Moreover, the priority processing unit 135 may give a priority on the basis of information other than the items illustrated in FIG. 15. For example, like the example illustrated in FIG. 9, the scenario part statistical information 124 stores the number of problem solutions. Therefore, the priority processing unit 135 may give a higher priority to a scenario pattern history that has a larger sum of the number of problem solutions for the scenario part. This reason is that a scenario pattern that has the larger number of problem solutions has a higher possibility by which the phenomenon of the monitoring target device 10 can be solved.

Furthermore, for example, the priority processing unit 135 may give a higher priority to a scenario pattern history that is more frequently selected by the filter unit 134. For example, in the example illustrated in FIG. 14, the filter unit 134 selects two scenario pattern histories of “1->2->3->4”, one scenario pattern history of “1->2->3->5”, and one scenario pattern history of “1->2->6->8”. In this case, the filter unit 134 may give a higher priority to the scenario pattern history of “1->2->3->4” other than the scenario pattern histories of “1->2->3->5” and “1->2->6->8”.

Moreover, for example, the priority processing unit 135 may give a higher priority to a scenario pattern history that includes scenario parts that are more frequently selected from split scenario parts as a split-destination scenario part among the scenario pattern histories selected by the filter unit 134. For example, in the example illustrated in FIG. 14, the split scenario part is the scenario part PA2. In the example illustrated in FIG. 14, the scenario part PA3 is selected three times as the split-destination scenario part of the scenario part PA2, and the scenario part PA6 is selected once as the split-destination scenario part of the scenario part PA2. In this case, the filter unit 134 may give a high priority to the scenario pattern histories corresponding to the history IDs “2”, “3”, and “5” other than the scenario pattern history corresponding to the history ID “7”.

Moreover, the priority processing unit 135 may give a priority to each weighted item illustrated in FIG. 15. For example, the priority processing unit 135 may compute a priority after multiplying a weight “W1” by the incident similarity, multiplying a weight “W2” by the scenario pattern occurrence number, multiplying a weight “W3” by the scenario pattern occurrence frequency, and multiplying a weight “W4” by the productive time. As a result, the network administrator can vary the level of importance of an item that determines a priority only by adjusting the weights “W1” to “W4”.

Returning to FIG. 2, the presenting unit 141 presents the scenario pattern selected by the filter unit 134. Specifically, when one scenario pattern is selected by the filter unit 134, the presenting unit 141 presents the one scenario pattern and the scheduled execution time of the scenario pattern.

Meanwhile, when a plurality of scenario patterns is selected by the filter unit 134, the presenting unit 141 presents the scenario patterns and the scheduled execution times of the scenario patterns in descending order of priorities given by the priority processing unit 135. At this time, the presenting unit 141 may present a scenario pattern of which the priority is higher than a predetermined threshold value or may present only one scenario pattern of which the priority is the highest.

For example, the presenting unit 141 may present a scenario pattern on a display device such as a display (not illustrated). Moreover, for example, the presenting unit 141 may transmit a scenario pattern to the network monitor 30 to present the scenario pattern to the network administrator.

When the scenario pattern presented by the presenting unit 141 is executed by the network administrator or the like, the updating unit 142 updates the history storage unit 120. Specifically, when the scenario pattern is executed, the updating unit 142 registers the scenario pattern in the incident information 121. At this time, the updating unit 142 takes out a new incident ID and generates a new incident corresponding to the incident ID. Then, the updating unit 142 stores a phenomenon ID corresponding to a phenomenon included in the new incident notification in the phenomenon ID of the new incident information. Moreover, the updating unit 142 stores attribute information included in the new incident notification in the attribute information of the incident information. Furthermore, the updating unit 142 sequentially stores the executed scenario parts in the history of the incident information.

Meanwhile, when the scenario pattern is executed, the updating unit 142 registers the newly taken-out incident ID in the phenomenon history information 122 corresponding to the phenomenon included in the new incident notification. Moreover, when the scenario pattern is executed, the updating unit 142 registers the newly taken-out incident ID in the attribute history information 123 corresponding to the hash value of the attribute information included in the new incident notification. Moreover, when the scenario pattern is executed, the updating unit 142 increments the number of selections of the scenario part statistical information 124, and registers the newly taken-out incident ID in the incident list of the scenario part statistical information 124. Moreover, when the phenomenon is solved by executing the scenario pattern, the updating unit 142 increments the number of problem solutions of the scenario part statistical information 124.

The updating unit 142 according to the first embodiment may automatically execute the scenario pattern presented by the presenting unit 141. For example, when the number of the scenario patterns presented by the presenting unit 141 is one, the updating unit 142 may sequentially and automatically execute scenario parts up to the scenario part in which “1 (automatic execution permission)” is stored in the simulation permission among the scenario parts included in the scenario pattern.

The scenario storage unit 110 and the history storage unit 120 described above are, for example, a semiconductor memory device such as a RAM (random access memory), a ROM (read only memory), and a flash memory, or a storage device such as a hard disk and an optical disc. Moreover, the evaluating unit 130, the presenting unit 141, and the updating unit 142 described above may be realized by, for example, an integrated circuit such as ASIC (application specific integrated circuit).

Processing Procedures by Measure Presentation Device of First Embodiment

Next, it will be explained about the processing procedures that are performed by the measure presentation device 100 according to the first embodiment with reference to FIG. 16. FIG. 16 is a flowchart illustrating the processing procedures that are performed by the measure presentation device 100 according to the first embodiment.

As illustrated in FIG. 16, when a new incident notification is not received from the network monitor 30 (Step S101: NO), the measure presentation device 100 waits the new incident notification. On the other hand, when the new incident notification is received from the network monitor 30 (Step S101: YES), the candidate extracting unit 131 of the measure presentation device 100 extracts a scenario pattern candidate from the scenario storage unit 110 (Step S102). Specifically, the candidate extracting unit 131 extracts a scenario pattern candidate from the scenario storage unit 110 on the basis of phenomenon information and attribute information included in the new incident notification.

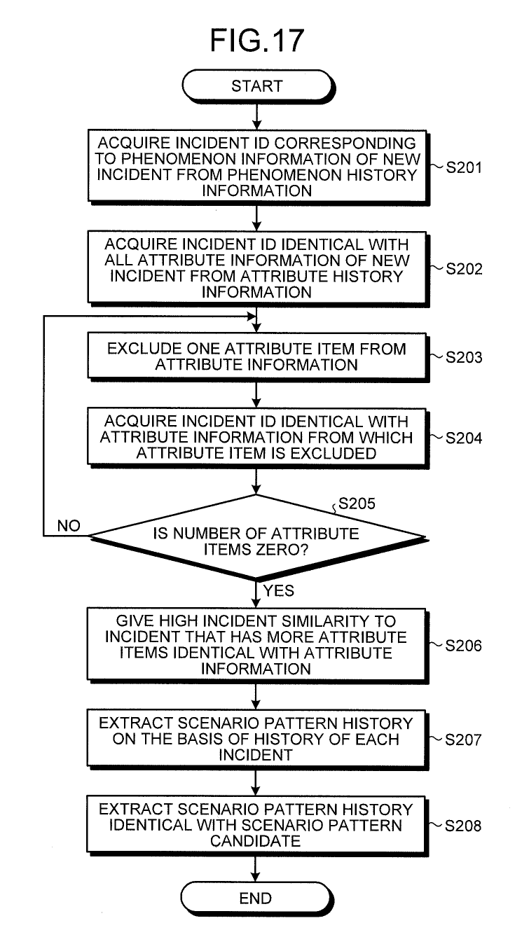

Next, the history extracting unit 132 performs a history extraction process (Step S103). It will be below described about the history extraction process that is performed by the history extracting unit 132 with reference to FIG. 17.

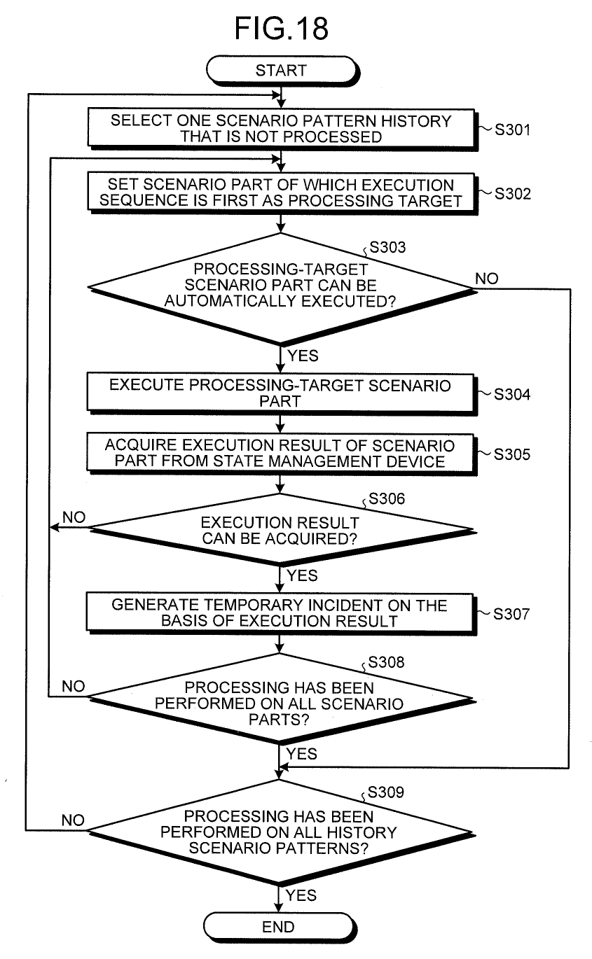

Next, the execution result applying unit 133 performs an execution result application process (Step S104). It will be below described about the execution result application process that is performed by the execution result applying unit 133 with reference to FIG. 18.

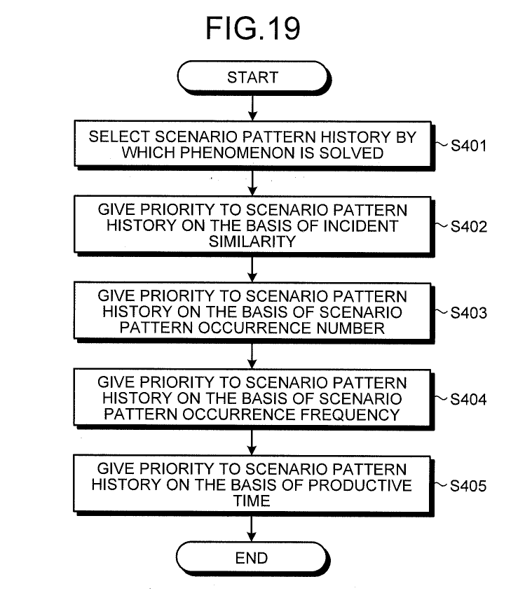

Next, the filter unit 134 and the priority processing unit 135 perform a filter priority process (Step S105). Specifically, the filter unit 134 performs a filtering process and the priority processing unit 135 performs a priority process. It will be below described about the filter priority process that is performed by the filter unit 134 and the priority processing unit 135 with reference to FIG. 19.

Then, the presenting unit 141 presents a scenario pattern having a high priority that is given by the priority processing unit 135, among the scenario patterns selected by the filter unit 134 (Step S106).

History Extraction Processing Procedures by History Extracting Unit

Next, it will be explained about the procedures of the history extraction process illustrated at Step S103 of FIG. 16 with reference to FIG. 17. FIG. 17 is a flowchart illustrating history extraction processing procedures that are performed by the history extracting unit 132.

As illustrated in FIG. 17, the history extracting unit 132 acquires an incident ID stored in association with the phenomenon information included in the new incident notification from the phenomenon history information 122 (Step S201).

Next, the history extracting unit 132 acquires an incident ID identical to all attribute information included in the new incident notification from the attribute history information 123 (Step S202). Next, the history extracting unit 132 excludes one attribute item from the attribute information included in the new incident notification (Step S203). Then, the history extracting unit 132 acquires an incident ID identical with the attribute information from which the attribute item is excluded from the attribute history information 123 (Step S204).

Next, when the number of attribute items of the attribute information included in the new incident notification is not zero (Step S205: NO), the history extracting unit 132 performs the processing procedures of Steps S203 and S204.

On the other hand, when the number of attribute items of the attribute information included in the new incident notification is zero (Step S205: YES), the history extracting unit 132 gives an incident similarity to the incident indicated by the incident ID acquired at Step S201. Specifically, the history extracting unit 132 gives a higher incident similarity to an incident that has more attribute items that are identical with the attribute information included in the new incident notification (Step S206).

Next, the history extracting unit 132 extracts scenario pattern histories that have been executed in past times on the basis of the scenario parts stored in the “history” of the incident acquired at Step S201 (Step S207). Then, the history extracting unit 132 extracts, among the scenario pattern histories, a scenario pattern history that is identical with the scenario pattern candidate extracted by the candidate extracting unit 131 (Step S208).

In this case, the incident similarity given at Step S206 is used when a priority is given to a scenario pattern history by the priority processing unit 135. It will be below described about a process that is performed by the priority processing unit 135 with reference to FIG. 19.

Execution Result Application Processing Procedures by Execution Result Applying Unit

Next, it will be explained about the procedures of the execution result application process illustrated at Step S104 of FIG. 16 with reference to FIG. 18. FIG. 18 is a flowchart illustrating execution result application processing procedures that are performed by the execution result applying unit 133.

As illustrated in FIG. 18, the execution result applying unit 133 selects one scenario pattern history on which the execution result application process is not performed from the scenario pattern histories extracted by the history extracting unit 132 (Step S301).

Next, the execution result applying unit 133 sets a scenario part of which the execution sequence is first as a processing target among the scenario parts included in the scenario pattern history selected at Step S301 (Step S302). Next, the execution result applying unit 133 determines whether the processing-target scenario part can be automatically executed on the basis of the information stored in the simulation permission of the processing-target scenario part (Step S303).

Then, when the processing-target scenario part can be automatically executed (Step S303: YES), the execution result applying unit 133 executes the measure content stored in the “measure” of the processing-target scenario part (Step S304). Next, the execution result applying unit 133 acquires the execution result of the measure content from the state management device 20 (Step S305).

Then, when the execution result can be acquired from the state management device 20 (Step S306: YES), the execution result applying unit 133 registers a temporary incident in the phenomenon history information 122 on the basis of the execution result (Step S307). On the other hand, when the execution result cannot be acquired from the state management device 20 (Step S306: NO), the execution result applying unit 133 returns the process control to Step S302. Specifically, the execution result applying unit 133 sets a scenario part to be next executed as a processing target (Step S302).

Then, when the process is not performed on all the scenario parts included in the scenario pattern history selected at Step S301 (Step S308: NO), the execution result applying unit 133 returns the process control to Step S302. On the other hand, when the process is performed on all the scenario parts included in the scenario pattern history (Step S308: YES), the execution result applying unit 133 determines whether the execution result application process is performed on all the scenario pattern histories (Step S309).

Then, when the execution result application process is not performed on all the scenario pattern histories (Step S309: NO), the execution result applying unit 133 returns the process control to Step S301 and selects one scenario pattern history on which the execution result application process is not performed. On the other hand, when the execution result application process is performed on all the scenario pattern histories (Step S309: YES), the execution result applying unit 133 terminates the process. In addition, when the processing-target scenario part cannot be automatically executed (Step S303: NO), the execution result applying unit 133 performs the process of Step S309. In this way, the execution result applying unit 133 narrows down the scenario pattern histories extracted by the history extracting unit 132 by using the latest state of the monitoring target device 10 that has the phenomenon.

In the example illustrated in FIG. 18, when the execution result cannot be acquired (Step S306: NO), the execution result applying unit 133 may perform the process of Step S309.

Filter Priority Processing Procedures by Filter Unit and Priority Processing Unit

Next, it will be explained about the procedures of the filter priority process illustrated at Step S105 of FIG. 16 with reference to FIG. 19. FIG. 19 is a flowchart illustrating filter priority processing procedures that are performed by the filter unit 134 and the priority processing unit 135.

As illustrated in FIG. 19, the filter unit 134 first selects a scenario pattern history by which the phenomenon is solved among the scenario pattern histories narrowed down by the execution result applying unit 133 (Step S401).

Next, the priority processing unit 135 gives a priority to the scenario pattern history selected by the filter unit 134 on the basis of the incident similarity (Step S402). For example, the priority processing unit 135 gives a higher priority to a scenario pattern history that has a larger incident similarity.

Next, the priority processing unit 135 gives a priority to the scenario pattern history selected by the filter unit 134 on the basis of the scenario pattern occurrence number (Step S403). For example, the priority processing unit 135 gives a higher priority to a scenario pattern history that has a larger scenario pattern occurrence number.

Next, the priority processing unit 135 gives a priority to the scenario pattern history selected by the filter unit 134 on the basis of the scenario pattern occurrence frequency (Step S404). For example, the priority processing unit 135 gives a higher priority to a scenario pattern history that has a larger scenario pattern occurrence frequency.

Next, the priority processing unit 135 gives a priority to the scenario pattern history selected by the filter unit 134 on the basis of the productive time (Step S405). For example, the priority processing unit 135 gives a higher priority to a scenario pattern history that has a smaller productive time.

### Effect of First Embodiment

As described above, the measure presentation device 100 according to the first embodiment stores a scenario part group including a split scenario part associated with several other scenario parts with respect to one execution result in the scenario storage unit 110, like the scenario part PA2 illustrated in FIG. 3. Moreover, like the example illustrated in FIG. 6, the measure presentation device 100 stores the scenario patterns performed in past times and the success or failure of the execution results in the scenario patterns in the history storage unit 120, with respect to the phenomenon of the monitoring target device 10. Then, when the monitoring target device 10 has the phenomenon, the measure presentation device 100 evaluates the effectiveness of the split-destination scenario part of the split scenario parts stored in the scenario storage unit 110 on the basis of the success or failure of the scenario patterns that have been executed in past times. Then, the measure presentation device 100 presents a scenario pattern that includes the split-destination scenario part that is effective.

As a result, the measure presentation device 100 according to the first embodiment can present an effective measure for the failure of the monitoring target device 10. In other words, even if there is a split scenario part associated with several scenario parts with respect to one execution result, the measure presentation device 100 can predict a scenario pattern that has a high problem solution possibility and present the scenario pattern to the network administrator. As a result, because the selection of a measure content dependent on the person can be removed, the measure presentation device 100 can perform efficient and appropriate measures on the phenomenon without relying on the capability and experience of the network administrator. In other words, if the measure presentation device 100 according to the first embodiment is used, errors in judgment of the network administrator can be prevented. As a result, the replay of a measure and the occurrence of a new failure can be prevented.

Moreover, because the executed scenario patterns are accumulated in the history storage unit 120, the measure presentation device 100 according to the first embodiment can save, as history information, a scenario pattern that has a higher reliability as the duration of use is longer. Because a scenario pattern candidate is evaluated on the basis of a scenario pattern having a high reliability, the measure presentation device 100 can present a scenario pattern that has a high problem solution possibility as the duration of use gets longer.

Moreover, because the measure presentation device 100 according to the first embodiment acquires the present state of the monitoring target device 10 that has the phenomenon and narrows down scenario pattern candidates, the measure presentation device 100 can present an appropriate scenario pattern for the present phenomenon.

Moreover, the measure presentation device 100 according to the first embodiment computes an incident similarity that is a similarity between the present phenomenon and the past phenomenon and preferentially presents a scenario pattern that has a high incident similarity. As a result, the measure presentation device 100 according to the first embodiment can present a scenario pattern that has a high problem solution possibility on the basis of the scenario pattern performed on the past phenomenon similar to the present phenomenon.

Moreover, as illustrated in FIG. 15, the measure presentation device 100 according to the first embodiment narrows down scenario patterns that have been executed in past times, on the basis of a scenario pattern occurrence number, a scenario pattern occurrence frequency, a productive time, and the like besides an incident similarity. As a result, the measure presentation device 100 according to the first embodiment can present a scenario pattern that has a high problem solution possibility and can promptly respond to the phenomenon.

### [b] Second Embodiment

As illustrated in FIG. 16, in the first embodiment, it has been explained about the case where the history extraction process is performed and then the execution result application process is performed. In other words, the measure presentation device 100 according to the first embodiment extracts a scenario pattern history in accordance with the history extraction process and performs the execution result application process on the scenario pattern history. However, the measure presentation device may perform the execution result application process on a scenario pattern candidate and then perform the history extraction process on the scenario pattern candidate. In the second embodiment, it will be explained about an example of the measure presentation device that performs the execution result application process and then performs the history extraction process.

Configuration of Measure Presentation Device by Second Embodiment

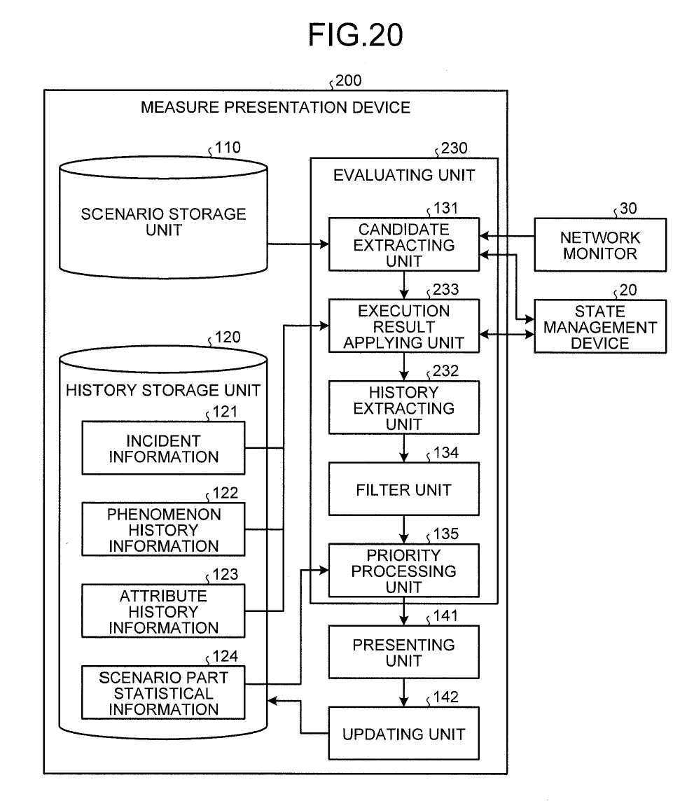

First, it will be explained about a measure presentation device 200 according to the second embodiment with reference to FIG. 20. FIG. 20 is a diagram illustrating an example configuration of the measure presentation device 200 according to the second embodiment. Hereinafter, components having the same functions as those of the components illustrated in FIG. 2 have the same reference numbers, and the detailed descriptions are omitted. As illustrated in FIG. 20, the measure presentation device 200 according to the second embodiment includes an evaluating unit 230. The evaluating unit 230 includes an execution result applying unit 233 and a history extracting unit 232.

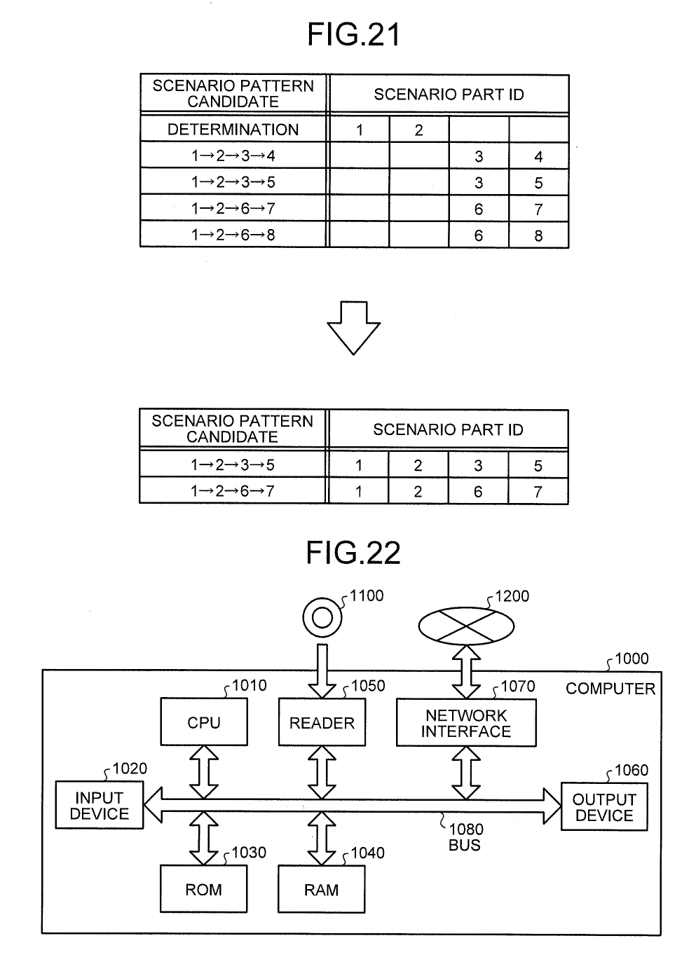

Herein, it will be explained about a process that is performed by the execution result applying unit 233 and the history extracting unit 232 with reference to FIG. 21. FIG. 21 is a diagram illustrating an example of a narrowing down process that is performed by the execution result applying unit 233 and the history extracting unit 232. The upper stage of FIG. 21 indicates an example of scenario pattern candidates that are extracted by the candidate extracting unit 131. In this case, it is assumed that the scenario pattern candidates extracted by the candidate extracting unit 131 are similar to the example illustrated in FIG. 11.

The execution result applying unit 233 performs the execution result application process on the scenario pattern candidates illustrated in the upper stage of FIG. 21. Specifically, the execution result applying unit 233 virtually executes scenario parts that can be automatically executed by the permission among the scenario parts included in the scenario pattern candidates illustrated in the upper stage of FIG. 21. Specifically, the execution result applying unit 233 virtually executes scenario parts for which “1 (automatic execution permission)” is stored in “simulation permission”.

In the example illustrated in FIG. 21, the execution result applying unit 233 executes the measure “acquisition of the state of Y” that is stored in the “measure” of the scenario part PA3 corresponding to the scenario part ID “3”. Moreover, the execution result applying unit 233 executes the measure “acquisition of the state of Z” that is stored in the “measure” of the scenario part PA6 corresponding to the scenario part ID “6”.

Herein, it is assumed that the execution result of the measure “acquisition of the state of Y” of the scenario part PA3 is “OK” and the execution result of the measure “acquisition of the state of Z” of the scenario part PA6 is “NG”. In this case, as illustrated in the lower stage of FIG. 21, the execution result applying unit 233 narrows down scenario pattern candidates to “1->2->3->5” and “1->2->6->7”.

The history extracting unit 232 performs the history extraction process on the scenario pattern candidates narrowed down by the execution result applying unit 233. Specifically, similarly to the history extracting unit 132 illustrated in FIG. 2, the history extracting unit 232 acquires an incident ID stored in association with phenomenon information included in a new incident notification from the phenomenon history information 122. Moreover, the history extracting unit 232 gives an incident similarity to the incident ID acquired from the phenomenon history information 122. Moreover, the history extracting unit 232 extracts scenario pattern histories that have been executed in past times on the basis of the scenario parts stored in the “history” of the incident acquired from the phenomenon history information 122. Then, the history extracting unit 232 according to the second embodiment extracts scenario pattern histories identical with the scenario pattern candidates narrowed down by the execution result applying unit 233 among the scenario pattern histories extracted from the phenomenon history information 122.

### Effect of Second Embodiment

As described above, the measure presentation device 200 according to the second embodiment narrows down scenario pattern candidates by using the present state of the monitoring target device 10 and evaluates the scenario pattern candidates by using the scenario pattern histories that have been executed in past times. As a result, because the measure presentation device 200 previously narrows down scenario pattern candidates that are an evaluation target even if enormous amount of scenario pattern histories are saved, the measure presentation device 200 can present an effective measure at high speed in accordance with a low-load process. In other words, when the measure presentation device 200 is used, a more prompt action can be performed on a phenomenon.

Each component of each device illustrated in the embodiments is a functional concept. Therefore, these components are not necessarily constituted physically as illustrated in the drawings. In other words, the specific configuration of dispersion/integration of each device is not limited to the illustrated configuration. Therefore, all or a part of each device can dispersed or integrated functionally or physically in an optional unit in accordance with various types of loads or operating conditions. For example, the filter unit 134 and the priority processing unit 135 illustrated in FIG. 2 may be integrated. Moreover, the history extracting unit 132 illustrated in FIG. 2 may be dispersed into, for example, a computing unit that computes an incident similarity and an extracting unit that extracts a scenario pattern history.

A program can be created that is obtained by describing the measure presentation process performed by the measure presentation device according to the embodiments in a language that can be executed by a computer. In this case, the computer executes the program to obtain the same effects as those of the embodiments. Furthermore, the same measure presentation process as that of the embodiments may be realized by recording the program in a computer-readable recording medium and making the computer read and execute the program recorded in the recording medium.

FIG. 22 is a diagram illustrating a hardware configuration example of a computer 1000 that realizes the measure presentation process. As illustrated in FIG. 22, the computer 1000 includes a CPU 1010 that executes the program, an input device 1020 that inputs data, a ROM 1030 that stores various types of data, and a RAM 1040 that stores operation parameters. The computer 1000 further includes a reader 1050 that reads a program from a recording medium 1100 that records the program for realizing the measure presentation process and an output device 1060 such as a display. Furthermore, the computer 1000 includes a network interface 1070 that transmits and receives data to and from another computer via a network 1200. The CPU 1010, the input device 1020, the ROM 1030, the RAM 1040, the reader 1050, the output device 1060, and the network interface 1070 are connected by a bus 1080.

The CPU 1010 reads the program recorded in the recording medium 1100 via the reader 1050 and then executes the program to realize the measure presentation process. As an example, the recording medium 1100 includes an optical disc, a flexible disk, CD-ROM, a hard disk, and the like. The program may be introduced into the computer 1000 via the network 1200. At this time, the network 1200 may be a wireless network or a wired network.

As described above, according to an aspect of the present invention, effective measure against the failure of the monitoring target device can be presented.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A measure presentation device comprising:
a measure storage unit that stores therein measure contents that are sequentially performed on a phenomenon of a device in association with an execution result of one measure content and a measure content performed next to the measure content;
a history storage unit that stores therein measure procedure histories indicating the measure contents sequentially performed in past times against the phenomenon of the device and successes or failures of the measure procedure histories;
an evaluating unit that evaluates, when the phenomenon occurs from the device, which of measure procedures including measure contents that are split from and associated with one execution result is effective among measure procedures determined from the measure contents stored in the measure storage unit on the basis of the successes or the failures of the measure procedure histories stored in the history storage unit; and
a presenting unit that presents the measure procedure that is evaluated to be effective by the evaluating unit.

2. The measure presentation device according to claim 1, wherein
the evaluating unit includes:
a candidate extracting unit that acquires, when the phenomenon occurs from the device, the measure contents corresponding to the phenomenon from the measure storage unit and extracts measure procedure candidates determined from the acquired measure contents;
a history extracting unit that extracts measure procedure histories identical with the measure procedure candidates extracted by the candidate extracting unit among the measure procedure histories stored in the history storage unit in association with the phenomenon of the device; and
a selecting unit that selects a measure procedure history for which an execution result is a success from the measure procedure histories extracted by the history extracting unit, and
the presenting unit presents the measure procedure history that is selected by the selecting unit.

3. The measure presentation device according to claim 2, wherein
the evaluating unit further includes an execution result applying unit that executes a measure content for which execution is permitted among measure contents included in the measure procedure histories extracted by the history extracting unit and narrows down the measure procedure histories on the basis of an execution result of the measure content, and
the selecting unit selects a measure procedure history for which an execution result is a success among the measure procedure histories narrowed down by the execution result applying unit.

4. The measure presentation device according to claim 1, wherein
the evaluating unit includes:
a candidate extracting unit that acquires, when the phenomenon occurs from the device, the measure contents corresponding to the phenomenon from the measure storage unit and extracts measure procedure candidates determined from the acquired measure contents;
an execution result applying unit that executes a measure content for which execution is permitted among measure contents included in the measure procedure candidates extracted by the candidate extracting unit and narrows down the measure procedure candidates on the basis of an execution result of the measure content;
a history extracting unit that extracts measure procedure histories identical with the measure procedure candidates narrowed down by the execution result applying unit among the measure procedure histories stored in the history storage unit in association with the phenomenon of the device; and
a selecting unit that selects a measure procedure history for which an execution result is a success from the measure procedure histories extracted by the history extracting unit, and
the presenting unit presents the measure procedure history that is selected by the selecting unit.

5. The measure presentation device according to claim 2, wherein
the history storage unit further stores attribute information on the device from which the phenomenon has occurred in past times,
the evaluating unit further includes:
a computing unit that computes, when the phenomenon occurs form the device, a similarity between the attribute information on the device and attribute information stored in the history storage unit for each the measure procedure history; and
a priority processing unit that gives, among the measure procedure histories extracted by the history extracting unit, a higher priority to the measure procedure history that has the higher similarity computed by the computing unit, gives a higher priority to the measure procedure history that has been more frequently executed in past times, gives a higher priority to the measure procedure history that has been more short executed in past times, and gives a higher priority to the measure procedure history that includes the measure content that has been more frequently executed in past times, and
the presenting unit preferentially presents the measure procedure candidate for which the high priority is set by the priority processing unit.

6. The measure presentation device according to claim 4, wherein
the history storage unit further stores attribute information on the device from which the phenomenon has occurred in past times,
the evaluating unit further includes:
a computing unit that computes, when the phenomenon occurs form the device, a similarity between the attribute information on the device and attribute information stored in the history storage unit for each the measure procedure history; and
a priority processing unit that gives, among the measure procedure histories extracted by the history extracting unit, a higher priority to the measure procedure history that has the higher similarity computed by the computing unit, gives a higher priority to the measure procedure history that has been more frequently executed in past times, gives a higher priority to the measure procedure history that has been more short executed in past times, and gives a higher priority to the measure procedure history that includes the measure content that has been more frequently executed in past times, and
the presenting unit preferentially presents the measure procedure candidate for which the high priority is set by the priority processing unit.

7. A measure presentation method, comprising:
acquiring, when a phenomenon occurs from a device, measure contents from a measure storage unit that stores therein measure contents that are sequentially performed on the phenomenon in association with an execution result of one measure content and a measure content performed next to the measure content;
evaluating which of measure procedures including measure contents that are split from and associated with one execution result is effective among measure procedures determined from the measure contents acquired in the acquiring measure contents on the basis of successes or failures of measure procedure histories indicating the measure contents sequentially performed in past times; and
presenting the measure procedure that is evaluated to be effective in the evaluating.

8. A non-transitory computer readable storage medium storing therein a measure presentation program causing a measure presentation device to execute a process, comprising:
acquiring, when a phenomenon occurs from a device, measure contents from a measure storage unit that stores therein measure contents that are sequentially performed on the phenomenon in association with an execution result of one measure content and a measure content performed next to the measure content;
evaluating which of measure procedures including measure contents that are split from and associated with one execution result is effective among measure procedures determined from the measure contents acquired in the acquiring measure contents on the basis of successes or failures of measure procedure histories indicating the measure contents sequentially performed in past times; and
presenting the measure procedure that is evaluated to be effective in the evaluating.
